(19) United States
(12) Patent Application Publication
(10) Pub. No.: US 2014/0153825 A1
(43) Pub. Date: Jun. 5, 2014

(54) TECHNIQUE FOR ENABLING COLOR BLIND PERSONS TO DISTINGUISH BETWEEN VARIOUS COLORS

(71) Applicants: Peter W. J. Jones, Belmont, MA (US); Dennis W. Purcell, Medford, MA (US)

(72) Inventors: Peter W. J. Jones, Belmont, MA (US); Dennis W. Purcell, Medford, MA (US)

(21) Appl. No.: 14/174,520

(22) Filed: Feb. 6, 2014

Related U.S. Application Data
(63) Continuation of application No. 13/073,765, filed on Mar. 28, 2011, now abandoned.
Application No. 13/073,765 is a continuation-in-part of application No. 11/726,615, filed on Mar. 22, 2007, now Pat. No. 7,916,152.
Application No. 11/726,615 is a continuation-in-part of application No. 11/633,957, filed on Dec. 5, 2006, now abandoned.
Application No. 11/633,957 is a continuation-in-part of application No. 10/388,803, filed on Mar. 13, 2003, now Pat. No. 7,145,571.
(60) Provisional application No. 60/422,960, filed on Nov. 1, 2002.
(60) Provisional application No. 60/785,327, filed on Mar. 22, 2006.

(51) Int. Cl. G06T 5/00

(52) U.S. Cl. CPC G06T 5/00
USPC 382/167

(57) ABSTRACT

Systems and methods for processing data representative of a full color image. Such systems may comprise the steps of assisting a color blind person to indicate portions of an image which to their color-deficient vision are indistinguishable, and altering the image to cause those portions to become distinguishable and identifiable.

### REFERENCE TO RELATED APPLICATIONS

This application is a continuation-in-part of U.S. patent application Ser. No. 11/726,615 filed Mar. 22, 2007, now U.S. Pat. No. 7,916,152 entitled “Technique For Enabling Color Blind Persons To Distinguish Between Various Colors”, and naming Peter Jones and Dennis Purcell as inventors, which claims priority to U.S. Provisional Application Ser. No. 60/785,327 filed on Mar. 22, 2006, entitled “Technique For Enabling Color Blind Persons To Distinguish Between Various Colors,” and also naming Peter Jones and Dennis Purcell as inventors, and is a continuation-in-part of U.S. patent application Ser. No. 11/633,957 filed Dec. 5, 2006, entitled “Technique For Enabling Color Blind Persons To Distinguish Between Various Colors”, and naming Peter Jones and Dennis Purcell as inventors, which is a continuation-in-part of U.S. Ser. No. 10/388,803 filed Mar. 13, 2003, now U.S. Pat. No. 7,145,571 entitled “Technique For Enabling Color Blind Persons To Distinguish Between Various Colors”, also naming Peter Jones and Dennis Purcell as inventors, which claims priority to U.S. Provisional Application Ser. No. 60/422,960 filed Nov. 1, 2002, entitled “Technique For Enabling Color Blind Persons To Distinguish Between Various Colors”, also naming Peter Jones and Dennis Purcell as inventors, the contents of all of which are hereby incorporated by reference in their entirety.

### BACKGROUND

Color-blind persons have difficulty distinguishing various colors. Persons whose color vision is impaired include, for example, those who confuse reds and greens (e.g., either protanopia: having defective red cones or deuteranopia: having defective green cones). Jennifer Birch, Diagnosis of Defective Color Vision, Butterworth Heinman (2002). For these people visual discrimination of color-coded data is practically impossible when green, red or yellow data is adjacent. In the color space of such persons, the red-green hue dimension is missing, and red and green are both seen as yellow; they have only the yellow-blue dimension. Even people with normal color vision can, at times, have difficulty distinguishing between colors. As for elderly persons, as a person ages clouding of the lenses of their eyes tends to occur, due, for example, to cataracts. The elderly often experience changes in their ability to sense colors, and many see objects as if they have been viewed through yellowish filters. Additionally, over time ultraviolet rays degenerate proteins in the eye, and light having short wavelengths is absorbed and blue cone sensitivity is thereby reduced. As a result, the appearance of all colors changes, yellow tending to predominate, or a blue or a bluish violet color tends to become darker. Specifically, “white and yellow,” “blue and black” and “green and blue” are difficult to distinguish. Similarly, even a healthy individual with “normal” vision can perceive colors differently when they are at an altitude that is greater than they are normally used to, or under certain medications.

To overcome the inability to distinguish colors, such individuals become adept at identifying and learning reliable cues that indicate the color of an object, such as by knowing that a stop sign is red or that a banana is typically yellow. However, absent these cues, the effect of being color-blind is that they are often unable to reliably distinguish colors of various objects and images, including in cases where the color provides information that is important or even critical to an accurate interpretation of the object or image. Common examples of such objects and images include lighted and non-lighted traffic signals, and pie-charts/graphs of financial information and maps. Moreover, with the proliferation of color computer displays, more and more information is being delivered electronically and visually and usually with color coded information.

To address the fact that important information may be color coded, engineers and scientists have developed a number of devices to aid a color-blind person. For example, U.S. Pat. No. 4,300,819 describes eyeglasses for distinguishing colors using one colored and one clear lens. Similarly, U.S. Pat. No. 4,998,817 describes a corneal contact lens for distinguishing of colors, which is clear except for a thin red exterior layer covering the area admitting light to the pupil.

Although such devices provide some benefit, they are cumbersome to use and have limited effectiveness in that only one color is adjusted, and the user cannot expand or change the manner in which the device alters the perceived color space.

Thus, a user viewing a pie chart that includes a plurality of colors that are outside of the perceptible color space of his or her vision, will have only a moderately improved understanding of the information being conveyed in the pie chart. Therefore, a great load is imposed on such persons when they must read or edit data using a color computer display terminal. In addition, these users cannot locate information on a screen that is displayed using certain colors or color combinations, and thus might not be able to read important notices. For example, when such a user employs a service or resource provided via the Internet, such as an electronic business transaction, or an on-line presentation, it may be that important information or cautionary notes are displayed using characters in colors that the individual may not be able to distinguish.

Accordingly, there is a need for improved systems for aiding in the identification of colors and color-coded information.

### SUMMARY

The systems and methods described herein enable a user to more easily distinguish or identify information that has been color-coded within an image. Although the systems and methods described herein will be discussed with reference to systems and applications adapted to aid a color blind user, it will be understood that these systems and methods may be employed to help any individual distinguish or understand color coded information. In general, color blind persons have difficulty in differentiating between two or more colors. For instance, a red/green color blind person may have difficulty in interpreting the signals of traffic lights or marine navigation aides. Also, mixed colors such as brown (green+red), magenta (red+blue) and cyan (green+blue) can be difficult to distinguish. Accordingly, it is an advantage of this technique to permit color blind persons to distinguish various colors or color-coded information, such as red information from green information.

In one aspect, the systems and methods described herein include methods for processing data representative of a full color image, comprising the steps of identifying a color space associated with the data, identifying a first portion of the color space being indistinguishable to color blind individuals, processing the data to identify a second portion of the color space that is perceptible to color blind individuals, and processing the first portion of the color space as a function of colors in the second portion of the color space.

This technique re-maps color information from one portion of the color-space to another portion. Alternately, this technique can remap color information onto a dimension that is not color based, such as texture (e.g. stripes). In alternate embodiments, the systems and methods described herein may be realized as software devices, such as device drivers, video drivers, application programs, and macros, that modify the normal output of a computer program to provide information that a color blind person can employ to identify or distinguish those sections of the display that are being presented in colors normally outside the color range of that person.

In another aspect, the systems and methods described herein include a method for processing a color image for assisting a color blind user. According to the method, a processor may receive an image having one or more colors. The processor may select a color from the image. The color may have one or more hue components. The processor may analyze the color to determine its hue components. The processor may uniquely determine a pattern based on the hue components of the color, and add the pattern the color. The processor may apply the pattern to portions of the image having the color, whereby the pattern is distinguishable to the color blind user.

In some embodiments, the selected color may be visible through the pattern applied by the processor. In some embodiments, the pattern may include at least one transparent portion and the color may be visible through the transparent portion. In some embodiments, the color may have a saturation value and the pattern may have a selected density. The selected density may correspond to the saturation value.

In some embodiments, the pattern may include a first set of stripes placed at a first angle. The first set of stripes may include a white stripe, a black stripe, and a transparent stripe. The first set of stripes may be a repeating arrangement of the white, black, and transparent stripes. The first angle may be determined based on a first one of the hue components. The first angle may be unique to the first one of the hue components. The first set of stripes may include stripes that are at least one of solid lines, dashed lines, dotted lines, and wavy lines. The pattern may include a second set of stripes placed at a second angle, resulting in a cross-hatched design.

In some embodiments, the hue components may include a first hue component and a second hue component. The first and second hue components may be associated with a first set of stripes and a second set of stripes, respectively. The first and second sets of stripes may be disposed at first and second angles. The pattern added to the color may include a cross-hatching of the first and second sets of stripes. In some embodiments, the first angle may be different from the second angle.

In yet another aspect, the systems and methods described herein include a system configured to process a color image for assisting a color blind user. The system may include a data memory having stored therein a color space defined by one or more colors associated with the image and data representative of the colors. The system may include a first processor to select a first color from the image. The first color may have one or more hue components. The system may include a second processor to analyze the first color to determine its hue components. The system may include a third processor to modify the data representative of the first color by adding a pattern to the first color. The pattern may be uniquely determined based on the hue components of the first color. The system may include a fourth processor to apply the pattern to portions of the image having the color, whereby the pattern is distinguishable to the user.

In some embodiments, the selected color may be visible through the pattern applied by the fourth processor. The pattern may include at least one transparent portion and the color may be visible through the transparent portion. In some embodiments, the color may have a saturation value and the pattern may have a selected density. The selected density may correspond to the saturation value.

In some embodiments, the pattern may include a first set of stripes placed at a first angle. The first set of stripes may include a white stripe, a black stripe, and a transparent stripe. The first set of stripes may be a repeating arrangement of the white, black, and transparent stripes. The first angle may be determined based on a first one of the hue components. The first angle may be unique to the first one of the hue components. The first set of stripes may include stripes that are at least one of solid lines, dashed lines, dotted lines, and wavy lines. The pattern may include a second set of stripes placed at a second angle, resulting in a cross-hatched design.

In some embodiments, the hue components may include a first hue component and a second hue component. The first and second hue components may be associated with a first set of stripes and a second set of stripes, respectively. The first and second sets of stripes may be disposed at first and second angles. The pattern added to the color may include a cross-hatching of the first and second sets of stripes. In some embodiments, the first angle may be different from the second angle.

In some embodiments, the data memory, the first processor, the second processor, the third processor, and/or the fourth processor may be disposed in an embedded system having a camera. In some embodiments, the data memory, the first processor, the second processor, the third processor, and/or the fourth processor may be disposed in at least one of a cell phone, a PDA, a digital camera, a visor, and a game console.

In yet another aspect, the systems and methods described herein may include a method for processing a color image on a mobile device for assisting a color blind user. The mobile device may include a processor, a camera, and a screen. The processor may receive an image from the camera. The image may have one or more colors. The processor may receive an input command to process the received image. The processor may select a color from the image. The color may have one or more hue components. The processor may analyze the selected color to determine its hue components. The processor may uniquely determine a pattern based on the selected color, whereby the pattern is distinguishable to the color blind user. The processor may apply the pattern to portions of the image having the color to create a processed image. The processor may display the processed image on the screen to the color blind user.

In some embodiments, the input command to process the received image may be received from the color blind user via a user input device. In some embodiments, the input command to process the received image may be automatically generated by the processor. In some embodiments, the processor may initiate a color blindness test to determine type of color blindness of the color blind user. The processor may receive input from the color blind user. The processor may determine the type of color blindness of the color blind user based on the received input. The processor may generate the input command to process the received image.

In some embodiments, the color blindness test may be initiated by the processor in response to receiving the image from the camera. In some embodiments, the color blindness test may be initiated by the processor in response to receiving the input command to process the received image from the color blind user via a user input device. In some embodiments, the processor may select the color from the image based on the type of color blindness of the color blind user. In some embodiments, the processor may determine that the color blind user has focused the camera for a fixed period of time on the received image being displayed on the screen. In response to this determination, the processor may generate the input command to process the received image.

In some embodiments, the color image may be processed in real time. The color image my be a frame of a live video feed. Frames of the live video feed may be extracted as color images and processed in real time for the color blind user.

In yet another aspect, the systems and methods described herein include a mobile device for processing an image to be detectable by a color blind user. The mobile device may include a processor, a camera in communication with the processor, and a screen in communication with the processor. The camera may be configured to capture an image having one or more colors. The screen may be configured to display the image. The processor may receive the image from the camera. The processor may receive an input command to process the received image. The processor may select a color from the image. The color may have one or more hue components. The processor may analyze the selected color to determine its hue components. The processor may uniquely determine a pattern based on the selected color, whereby the pattern is distinguishable to the color blind user. The processor may apply the pattern to portions of the image having the color to create a processed image. The processor may display the processed image on the screen to the color blind user.

### BRIEF DESCRIPTION OF THE DRAWINGS

The foregoing and other objects and advantages of the systems and methods described herein will be appreciated more fully from the following further description thereof, with reference to the accompanying drawings wherein;

FIGS. 1A and 1B are illustrations depicting a filter panel comprised of a pattern of transparent minus-red electronic filter elements.

FIGS. 2A and 2B are illustrations depicting a filter panel comprised of a pattern of transparent minus-red electronic filter elements alternating with transparent neutral density electronic filter elements.

FIG. 3 is an illustration depicting a possible application of the systems and methods described herein mounted as an adjustable visor to aid the driver in interpreting traffic signals.

FIGS. 4-6 depict color charts and a process for coding information on that color chart into an alternate display channel.

FIGS. 7-9 illustrate a process for encoding color information into a format detectable by a color blind user.

FIGS. 10 and 11 depict an alternative process and method for encoding color information into a format detectable by a color blind user.

FIGS. 12A-12C depict a process for encoding color information into a format detectable by a color blind user.

FIG. 12D-12E depict a mobile device having a software component installed for processing color information into a format detectable by a color blind user, according to an illustrative embodiment.

FIGS. 13A-13G depict a process for rotating a hue space from a first position to a second position.

FIG. 14 depicts a pseudo color space comprising a plurality of hatching patterns.

FIG. 15 depicts a plurality of color components assigned to respective hatching patterns.

FIG. 16 depicts a process for superimposing hatching patterns to create a unique composite hatch pattern.

FIG. 17 depicts a process for allowing a user to identify a type of color blindness to consider when processing an image.

FIG. 18 depicts a GUI tool for achieving hue rotation.

FIG. 19A depicts a front view of a mobile device having a software component installed for processing color information, according to an illustrative embodiment.

FIG. 19B depicts a back view of a mobile device having a software component installed for processing color information, according to an illustrative embodiment.

FIG. 20 depicts a block diagram of a of a mobile device having a software component installed for processing color information, according to an illustrative embodiment.

FIG. 21A-21C depict process flow diagrams for a mobile device executing a software component for processing colors in an image for a color-blind person, according to an illustrative embodiment.

### DESCRIPTION OF THE ILLUSTRATED EMBODIMENTS

To provide an overall understanding of the systems and methods described herein, certain illustrative embodiments will now be described. However, it will be understood by one of ordinary skill in the art that the systems and methods described herein can be adapted and modified for other suitable applications and that such other additions and modifications will not depart from the scope hereof.

In one embodiment, the techniques, systems, and methods described herein enable a color blind person, as well as a person with normal color vision, to distinguish various colors by employing a device that creates an intermittent blinking pattern, and, thus, serves an additional channel of information. More specifically, the systems and methods described herein include apparatus and processes that code color information that is indistinguishable by a color blind individual onto a channel of information that is detectable by the individual. In one embodiment, the systems and methods described herein include software programs that analyze and modify color information associated with a display. As described in more detail below, these programs can, in one practice, identify or receive user input representative of the type of color blindness to address. For example, the user may indicate that they have red-green color blindness. In response to this input, the process may review, on a pixel-by-pixel basis, color information associated with an image being displayed. The process may determine the difference between the red and green color components, and thereby make a determination of the color information being displayed that is not detectable by the user. The process may then encode this color information in an alternate, optionally user-selectable way. For example, the user may chose to have the red or green components fade to white or darken to black. The rate at or extent to which colors fade or darken may vary according to user input the color information that was being presented. In this way, the user can see that portions of the image are fading in and out, indicating that these portions of the image carry color information that is otherwise indistinguishable. In this way, red or green portions of a display—such as red and green items on a map or navigation chart can be distinguished by the user.

The systems and methods described herein aid color-vision impaired individuals by processing color-coded information that is not perceptible to these individuals and recoding the information onto a channel that is perceptible to the individuals, such as by recoding the color information onto a visually perceptible temporal pattern that is detectable by all sighted people. To this end, these systems recode color coded information to allow color vision impaired people to differentiate between two colors, typically red and green.

The systems and methods described herein provide alternate ways to visually present information, and in particular color information to a user. These systems have wide applicability, including for providing systems that make it more easy for a user to distinguish color coded information presented in a pie chart, a graph, a map or in some other format. Additionally, these systems can process color information in a manner that presents the information in a format that can be perceived by a person with impaired color-vision. To this end, the systems and method described herein, inter alai, provide a user with control over the color palette and hues being used to display information. By controlling the color, a user can redirect color coded information into a format that is more easily perceived by the user.

### Interposing Filters (Temporal Encoding)

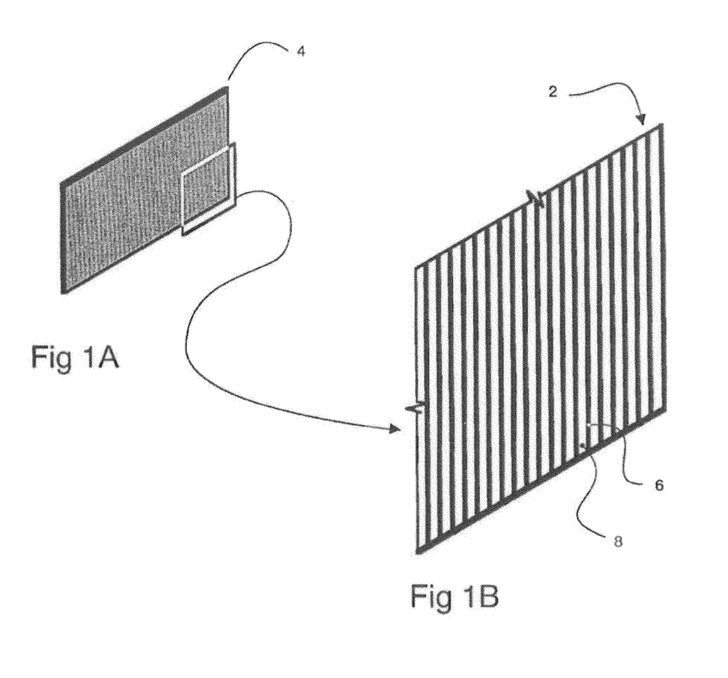

In one embodiment, the systems and methods disclosed herein interpose a filter between the user and the color coded information for the purpose of temporally encoding the color data. The system intermittently interposes a filter that blocks a certain color of light in front of a color blind person's eyes. For instance, FIGS. 1A and 1B show a filter panel 4 and a close-up of the filter panel 4. In this embodiment the filter panel 4 is made up of a pattern of transparent minus-red electronic filter elements 6 laid down on a transparent field 8. The pattern comprises vertical stripes of clear plastic and stripes of minus-red filter elements 16. Such filter elements 16 are commercially available, including LCD minus-red filters used in the color changing sun glasses manufactured and sold by Reliant technology company of Foster City Calif. and described is detail in U.S. Pat. No. 5,114,218, the contents of which are incorporated by reference. Such filters 16 may be integrated into the panel 4 as described in the referenced patent, so that the panel is formed as an LCD plate with the LCD minus-red filters 16 formed as a pattern of stripes integrated into the plate 4. Alternatively, the panel 4 may include minus-green filters or a filter of another selected color, and filter chosen will depend, at least in part on the application at hand. Similarly, the pattern may comprise vertical stripes, horizontal stripes, a checker board pattern or any other suitable pattern. These filter elements are switched on and off periodically so as to let red light pass through the panel one moment and block red light from passing through the next moment.

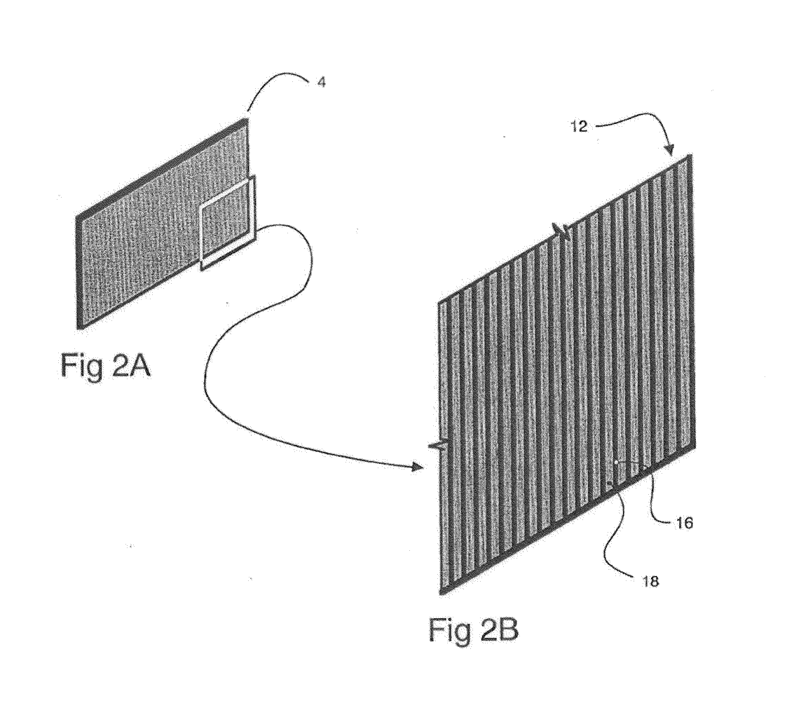

FIGS. 2A and 2B depict another filter panel 14 and its close-up 12. Through a combination of filter elements 16 and 18, this filter panel 14 minimizes the impression of flickering. Moreover, the filter panel 14 in FIG. 2B is comprised of a pattern of transparent minus-red electronic filters 16, alternating with transparent neutral density electronic filters 18. The neutral density filters may be any suitable neutral density filter. In one embodiment the neutral density filter includes a filter similar to the color filters described in the above referenced patent. However, rather than colors, the filter may provide for different levels of grey to allow for different density filters. The minus-red and neutral density filter elements 16 and 18 are turned on and off in an alternating fashion so that when the minus-red filter element 16 is on and blocking red light, the neutral density filter is off and passing light. Conversely, when the minus-red filter 16 is turned off and passing red light, the neutral density filter 18 is turned on and blocking a selected percentage of light. Accordingly, the impression of flickering is reduced or minimized when the minus-red filter 16 is switched on and off.

The filter panel 14 depicted in FIG. 2A as well as the filter panel 4 depicted in FIG. 1A can operate under microprocessor control. To this end, a microprocessor or a microcontroller may be employed for generating an electronic timing control circuit that can turn the filters 16 and 18 on and off in an alternating fashion and according to a period or frequency that is suitable for the application. Additionally, and optionally, the electronic filters 16 and 18 may be tunable for selecting the color or range of colors to be filtered. These microcontrollers can be developed using principles well known in the art. In further optional embodiments, the system can include a sensor that determines the lighting level of the relevant environment. Such optical sensors are known in the art and any suitable sensor that can measure the brightness of the environment may be employed. The brightness level may be used by the microcontroller to balance the amount of neutral density used by the system as a function of the brightness of the environment.

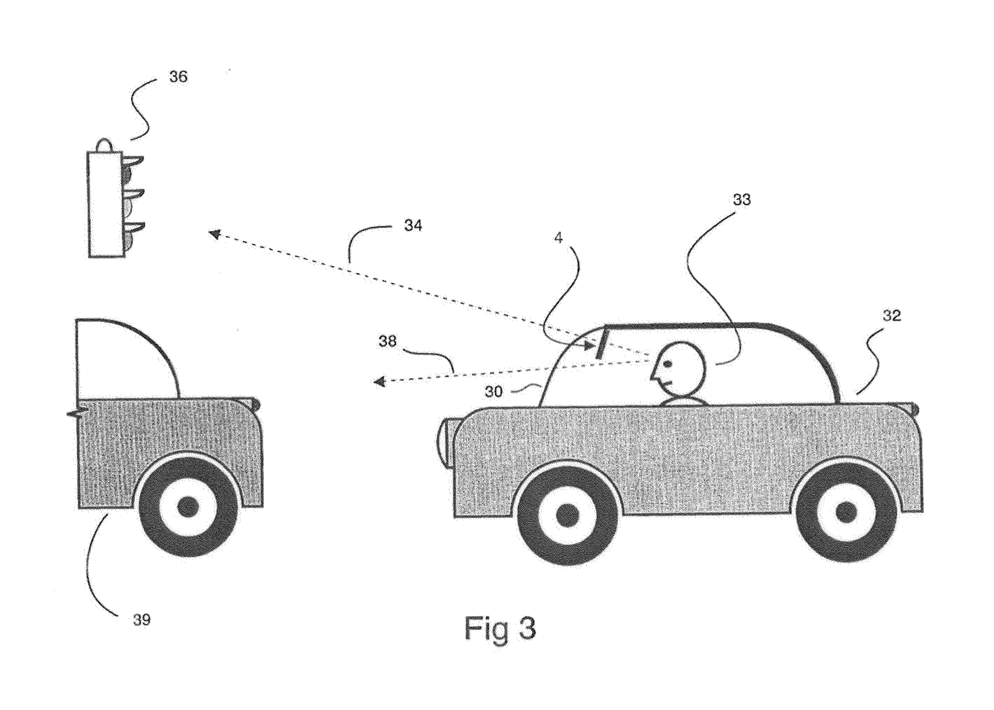

In alternate embodiments, a mechanical intermittent filter is provided. For example, in one such alternate embodiment, a mechanical filter comprises a plurality of rotatable filter elements disposed across the surface of a clear plate. Each filter can comprise a thin sheet of acetate that acts as a minus-red filter. The filter can be rotated in and out of the view of the user. To this end, each filter may be mounted on an axle and may be driven by a servo-motor. The servo motor can operate under the control of a micro controller. The filter may be mounted as shown in FIG. 3 to allow a user 33 to view traffic signals 36 through the filter. The user 33 has a straight line of sight 38 and a line of sight 34 that is inclined and travels through the visor panel 4 to the signal 36.

In operation, the user 33 moves the filter 4 or 14 into position just as a sun visor may be moved into position. The user 33 activates the filter 4 so that the filter 16 and 18 begin to intermittently filter out a selected color of light, such as red light. The result is that a red light viewed through the filter 4 appears to flash. Thus, the user 33 can distinguish between a red light or green light at the traffic signal 36. In this way, the filter 4 remaps the color information provided by traffic signal 36 into a temporal pattern that the user 33, even if red-green color blind can detect.

The technique of interposing an intermittent filter panel can be employed in numerous devices. Although, FIG. 3 depicts the use of an intermittent filter panel in an overhead visor to aid a driver 33 in distinguishing a red traffic signal 36 from a green signal 36 the filter can be used in numerous other applications including, marine navigation, air transport, and others. Additionally, other types of optical filters may be used including mechanical filter devices that rotate the filters in and out of the user's 33 line of sight, or can slide filters across the field of view so that the filters vibrate over the panel 4. Additionally, in certain optional embodiments, the filters can be formed in a pattern of tight stripes. For example, strips of red or green acetate placed of the surface of the panel. The panel 4 may be mounted on the vehicle 32 by a spring that allows the panel to vibrate as the vehicle 36 moves. The filters may be fixed is place on the panel, yet the movement of the panel 4 in a motion that is transverse to the user's 33 line of sight, effectively causes the filter to intermittently move across the user's 33 filed of view, thereby causing a traffic light 36 of the selected color to flash.

Coding Color Information into an Alternate Channel

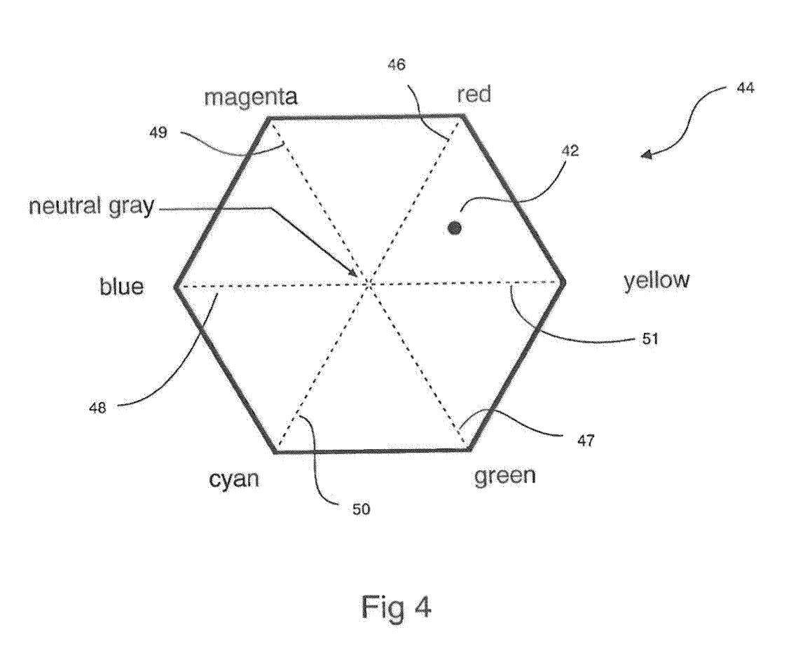

FIG. 4 depicts a slice 44 through a cube that represents a three dimensional color space. The color space can be any color space and it will be understood to represents all the possible colors that can be produced by an output device, such as a monitor, color printer, photographic film or printing press, or that appear in an image. The definition of various color spaces are known to those of skill in the art, and the systems and methods described herein may be employed with any of these defined color spaces, with the actual definition selected depending at least in part on the application. These models include the RGB color space model, which uses the three primary colors of transmitted light. The RGB standard is an additive color model as if you add red, green and blue light and you get white. A second known color space model uses reflected light. This subtractive color model attains white by subtracting pigments that reflect cyan, magenta and yellow (CMY) light. Printing processes, the main subtractive users, add black to create the CMYK color space. Aside from RGB and CMYK, there are other alternative color spaces; here are some of the more common:
INDEXED uses 256 colors. By limiting the palette of colors, indexed color can reduce file size while maintaining visual quality.
LAB COLOR (a.k.a. L*a*b and CIELAB) has a lightness component (L) that ranges from 0 to 100, a green to red range from +120 to −120 and a blue to yellow range from +120 to −120. LAB is used by such software as Photoshop as a intermediary step when converting from one color space to another. LAB is based on the discovery that somewhere between the optical nerve and the brain, retinal color stimuli are translated into distinctions between light and dark, red and green, and blue and yellow.
HSL a spherical color space in which L is the axis of lightness, H is the hue (the angle of a vector in a circular hue plan through the sphere), and S is the saturation (purity of the color, represented by the distance from the center along the hue vector).
MULTICHANNEL uses 256 levels of gray in each channel. A single Multichannel image can contain multiple color modes—e.g. CMYK colors and several spot colors—at the same time.
MONITOR RGB is the color space that reflects the current color profile of a computer monitor.
sRGB is an RGB color space developed by Microsoft and Hewlett-Packard that attempts to create a single, international RGB color space standard for television, print, and digital technologies.
ADOBE RGB contains an extended gamut to make conversion to CMYK more accurate.
YUV (aka Y′CbCr) is the standard for color television and video, where the image is split into luminance (i.e. brightness, represented by Y), and two color difference channels (i.e. blue and red, represented by U and V). The color space for televisions and computer monitors is inherently different and often causes problems with color calibration.
PANTONE is a color matching system maintained by Pantone, Inc.

When discussing color theory in general, particularly as it applies to digital technologies, there are several other important concepts:
HUE—The color reflected from, or transmitted through, an object. In common use, hue refers to the name of the color such as red, orange, or green. Hue is independent of saturation and lightness.
SATURATION (referred to as CHROMINANCE when discussing video)—The strength or purity of a color. Saturation represents the amount of gray in proportion to the hue, measured as a percentage from 0% (gray) to 100% (fully saturated).
LIGHTNESS—Lightness represents the brightness of a color from black to white measured on a scale of 1 to 100.
LOOK-UP TABLE—A look-up table is the mathematical formula or a store of data which controls the adjustment of lightness, saturation hue in a color image or images, and conversion factor for converting between color spaces.

Turning back to FIG. 4, there is depicted a slice 44 through a cube that represents a the R,G, B color space model. This is a representation of the color space known to those of skill in the art. The slice 44 represents a color space in which a plurality of colors can be defined. As shown in FIG. 4, six axes extend from the center point of the slice 44. Three of these axes are labeled red 46, green 47 and blue 48 respectively. The other three are labeled magenta 49, cyan 50 and yellow 51. Neutral is in the center of the color space. A specific color 42 exists in the color space 44, and is disposed about midway between the red 46 and yellow axes 51. This shows the relative amount of each color axis in the specific color 42. Thus, each point in the slice 44 represents a color that can be defined with reference to the depicted axes.

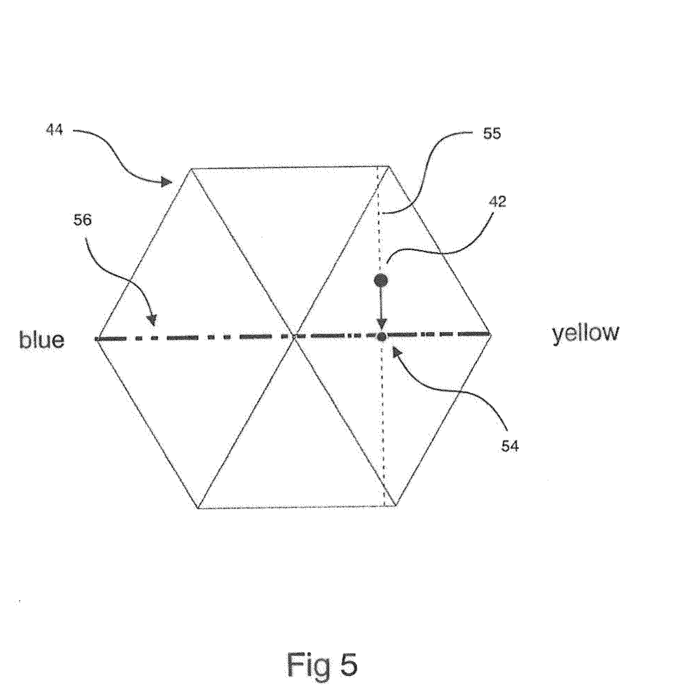

FIG. 5 depicts the color space 44 as seen by a person with red/green color blindness. As a color vision impaired person having red-green color blindness cannot distinguish red or green, the color space perceived by such a person is compressed or reduced. To such a person, all colors, such as the specific color 42, are defined only by their position 54 along the blue-yellow axis 56. Thus, the red component of color 42 is not differentiated by the person and only the component along the blue-yellow axis is differentiated. Thus, this person cannot distinguish between the color 42 and the color 54 that sits on the blue-yellow axis. As such, any information that has been color coded using the color 42 will be indistinguishable from any information that has been color coded using the color 54, or any other color that falls on line 55.

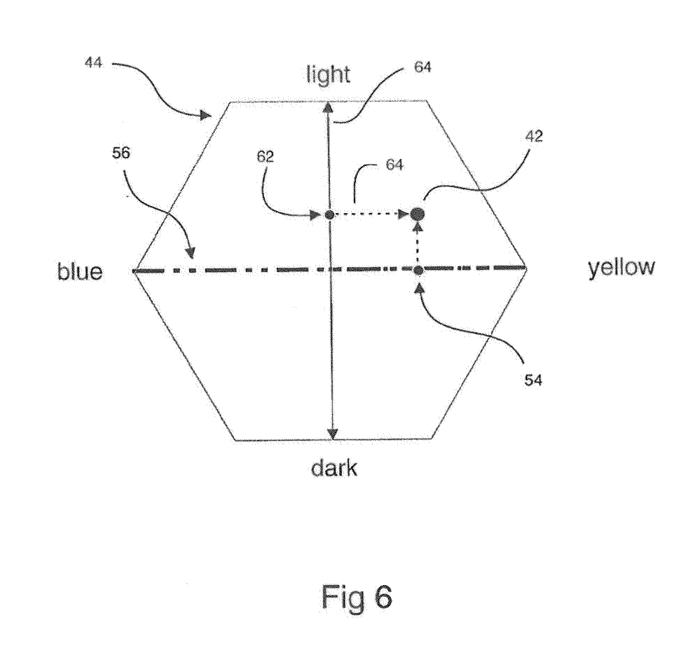

To address this, the systems and methods described herein, in some embodiments, allow a user to distinguish between colors along the line 55 by adding a temporal characteristic related to the color information being displayed. FIG. 6 depicts a method in accordance with these embodiments, where the red or green value of the specific color 42 is determined and converted into a selected value 62 on an axis 64 running from light to dark. To this end, and as discussed above, the color map and color 42 is now shown in relation to the axis 64, which represents different degrees of lightness and darkness and which is common in the LAB color space, that also employs a blue-yellow axis. The computer display is then instructed to intermittently change the lightness/darkness value of the specific color 42 to the new value 62, which is lighter or darker depending on the red or green value of the specific color 42. The two values, 62—which is represented temporally by means of a change in lightness/darkness—and 54 are sufficient to locate the actual hue of specific color 42 in a standard color space 44, even though the red/green color blind person has intrinsically only one axis of color perception that lies on the blue-yellow axis 56. Note that in this method, any color that does not have a red or green bias, such as blue or a neutral color, for example, will not have its lightness/darkness intermittently changed. Moreover, note that in one embodiment, the user selects colors having a red component or colors having a green component. In this way, the user can more easily distinguish between reds and greens. Optionally however, the user can have both the red and green color components translated into a degree of lightness/darkness at the same time. The display can lighten flash green-based colors at a rate that is much higher than red-based colors, or can lighten the red-based colors while darkening green-based colors. Either way the systems and methods described herein can recode the green and red hue component of the color 42 onto a temporal variation channel that can be perceived by the user.

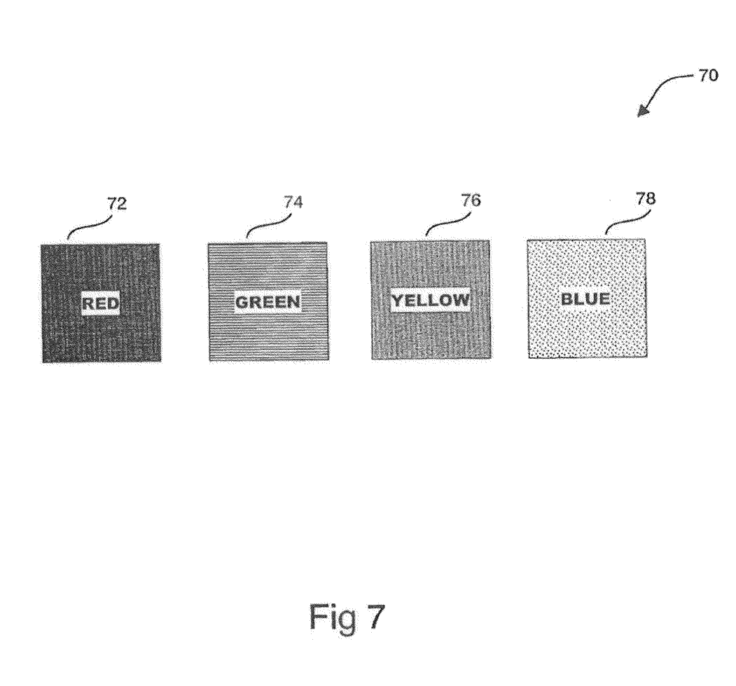

FIGS. 7-9 depict pictorially how the process depicted in FIGS. 4-6 may appear to the user wherein a full-color scene is presented in an alternate format wherein selected colors are encoded into a temporal pattern of alternating dark and light images. In one practice the FIGS. 7-9 represent a display, such as a computer display, that creates a color image. Specifically, FIG. 7 depicts a series of blocks 70 that include a red block 72, a green block 74, and yellow block 76 and a blue block 78. These blocks 70 represent a full-color scene of the type depicted on a computer display.

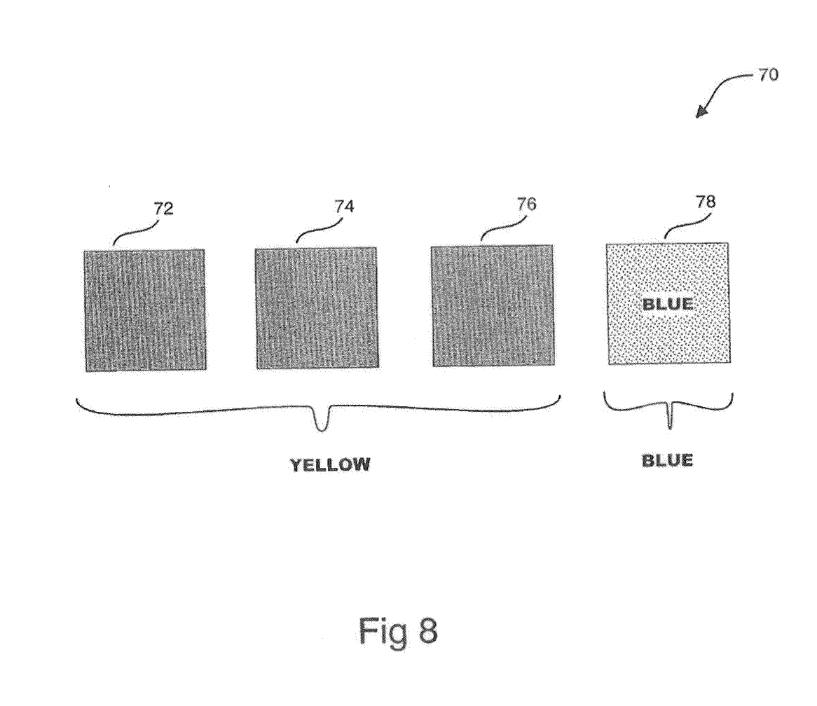

In FIG. 8 the scene is displayed using only blue-yellow colors, and simulating a red/green color blind person's perception. To this end, the series of blocks 70 are labeled to show that the first three blocks, including the green, red and yellow block all appear yellow to the color-blind user. Thus a display of color coded information that uses reds and greens will fail to convey to the color blind user information that can be used to distinguish between different blocks in the series 70. Thus, if information in red was meant to depict information of high priority, or for example that a stock price was going down, and information in green was meant to convey information of lower or normal priority or a stock price going up, the red-green color blind user would not be able to distinguish this information.

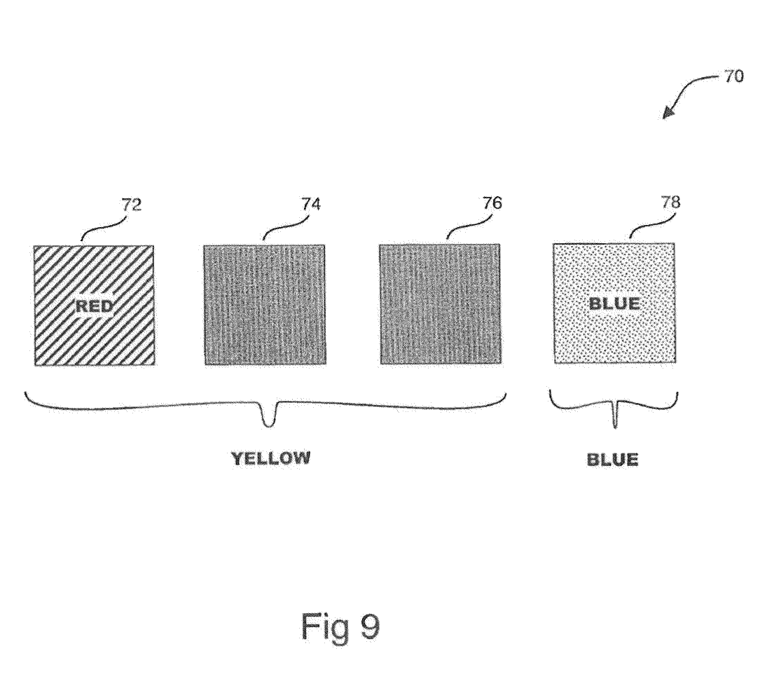

FIG. 9 illustrates that with the application of the systems and methods described herein a user can distinguish between red and green color-coded information. As shown in FIG. 9, the system described herein processes the red-based color components as described above so that red-colors are caused to “flash”, optionally at a rate that relates to the amount of red in the color. In this way the user can distinguish the high priority information, which is caused to flash, from the lower priority information, which does not flash. The systems described herein can allow the user, as discussed above, to select at different times, whether to process the red or the green components. Thus, in the embodiment of FIG. 9, the user can choose to process red colors first to determine high priority information and then subsequently process the green colors.

With this practice the systems and methods described herein may be realized as a device or video driver that processes the pixel information in the image to create a new image that more fully conveys to a color-blind person the information in the image. The software may be built into the application program that is creating the image, it may be user controllable so that the user can control the activation of the image processing as well as characteristics of how the image is processed. For example, the systems and methods described herein may provide a “hot-key” that the user can use to activate the process when desired.

Optionally, the systems and methods described herein may provide for mouse “roll-over” control wherein moving a cursor over a portion of the screen causes the image, or a color or shape, displayed on that portion of the screen to change at that location and/or at other locations of the display. For example, an image of a graph presented in different colors may be altered by moving the mouse over different portions of the graph to cause the image to change in a manner that communicates to a colorblind person the color-coded information being displayed. To this end, the image may change so that the portion under the cursor and matching colors elsewhere in the image are presented in a textured format, caused to flash, or in some other way altered so that the information being provided by the color of the display is presented in a manner that may be detected by a color blind person.

### Texture Mapping

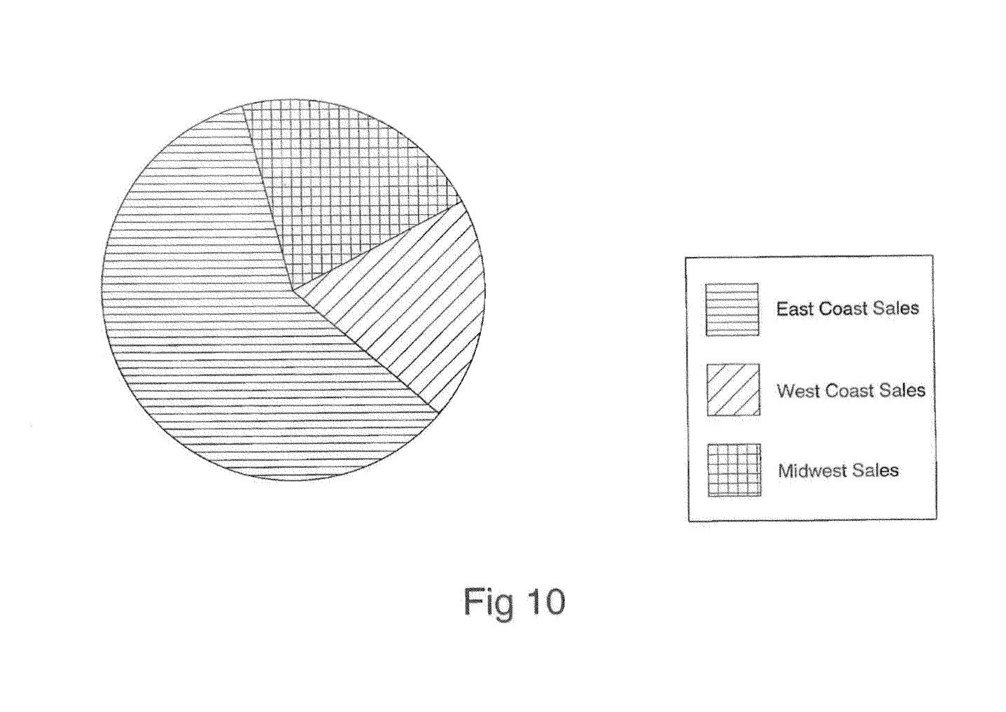

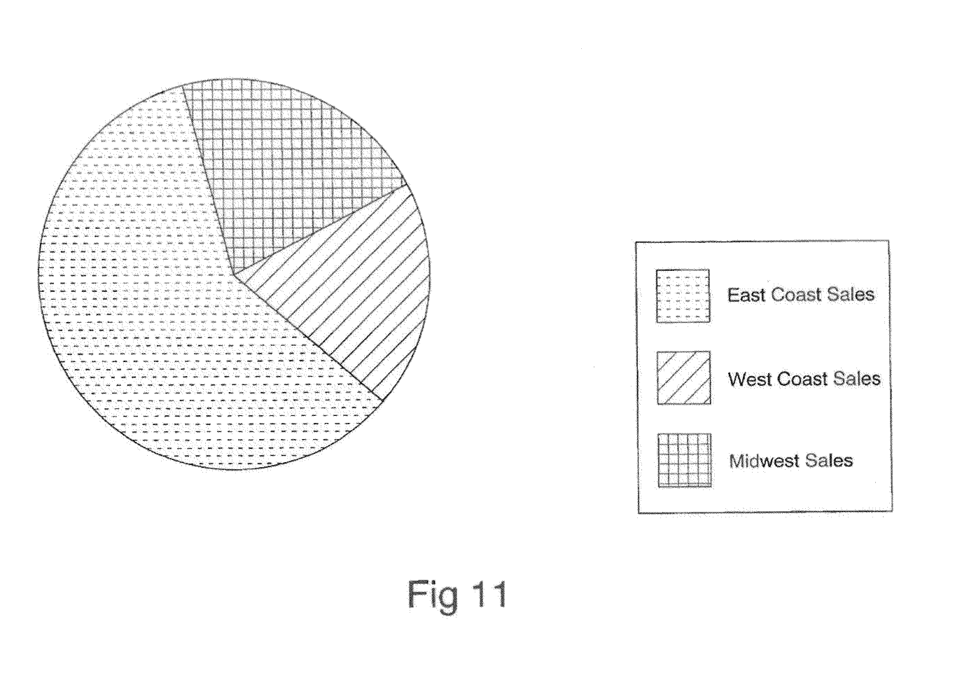

Turning to FIG. 10 an alternative embodiment is depicted. Specifically FIG. 10 depicts a display wherein in a pie chart is presented to a user. To the right of the pie chart is a key table that equates different colors on the graph to different kinds of information. In FIG. 10, solely for purpose of illustration, the colors are represented by different hatch patterns. In FIG. 10 the key table associates colors (depicted by hatch patterns) with different regions of the country. In this embodiment, the user is capable of rolling the cursor over the different colors presented in the key table. This causes the corresponding portion of the pie chart to alter in a manner that may be detected by a color blind person. For example, in FIG. 11, the user may place the cursor over the color used in the Key Table to describe “East Coast” sales. By doing this the system knows to flash or otherwise alter those portions of the pie chart that are presented in that color. Alternatively, the user can place the cursor over a portion of the pie chart and the color in the Key Table associated with that color can flash. Optionally, both functions may be simultaneously supported.

Alternatively, when colored data in an image is known to have certain color names, for example, when a map of highway congestion is known to mark congested zones as red and uncongested zones as green, the colorblind person will be able to select a desired color name from an on-screen list of color names, and colors in the image corresponding to that name will flash or be otherwise identified.

Although, FIG. 10 depicts the image as being redrawn to include a hatch pattern, it shall be understood that shading, grey scale or any other technique may be employed to amend how the selected color information is presented to the user. A black and white bitmap may be created, as well as a grayscale representation that uses for example 256 shades of gray, where each pixel of the grayscale image has a brightness value ranging from 0 (black) to 255 (white).

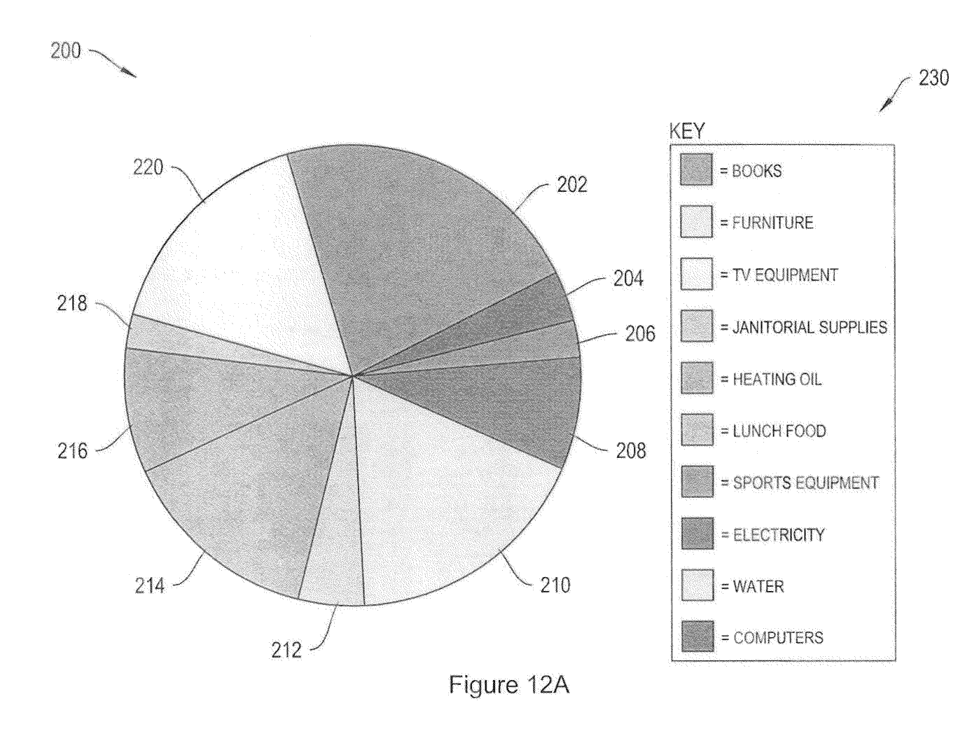

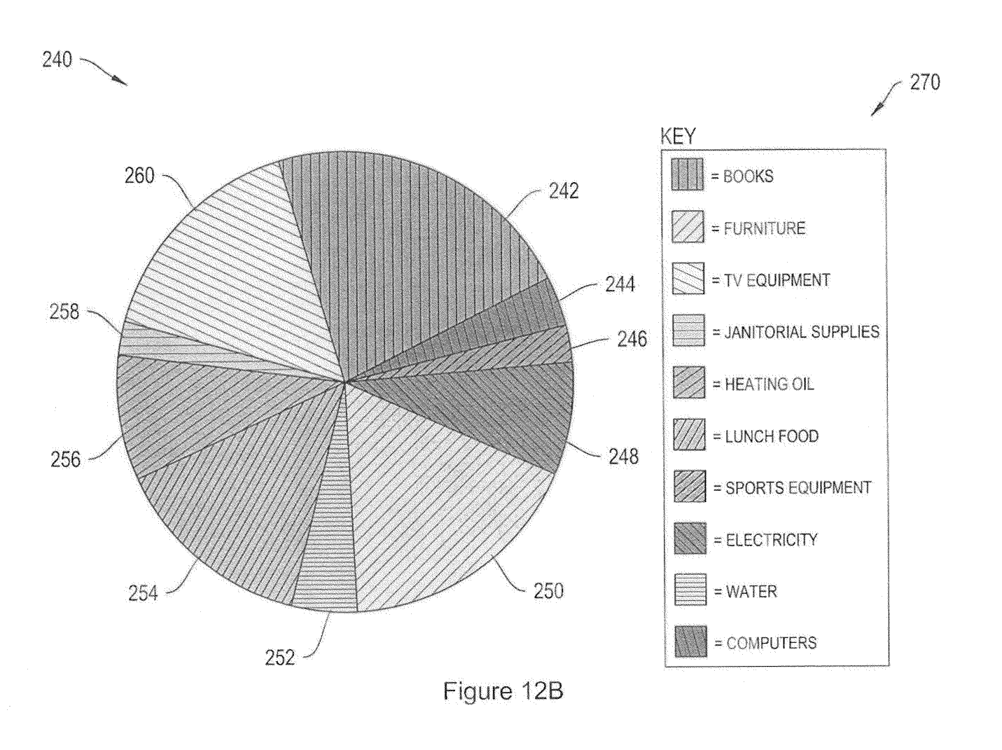

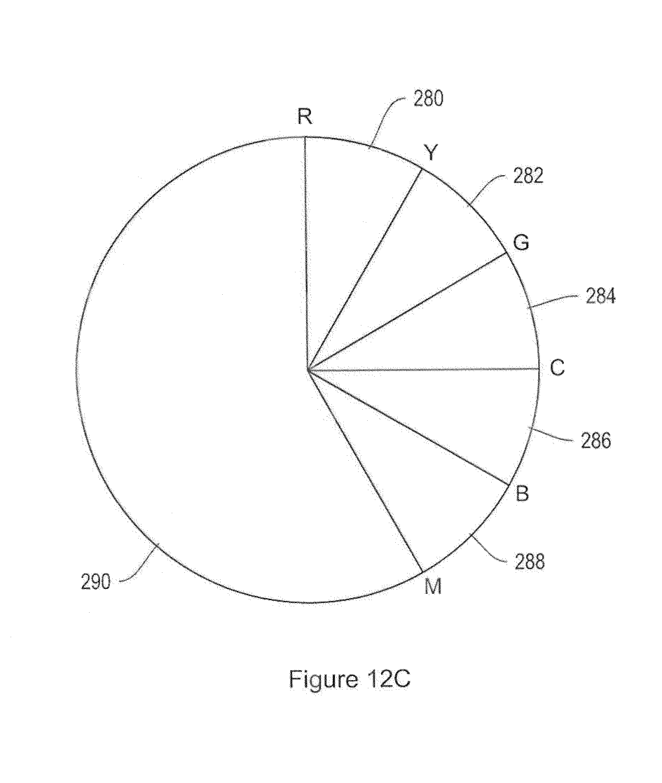

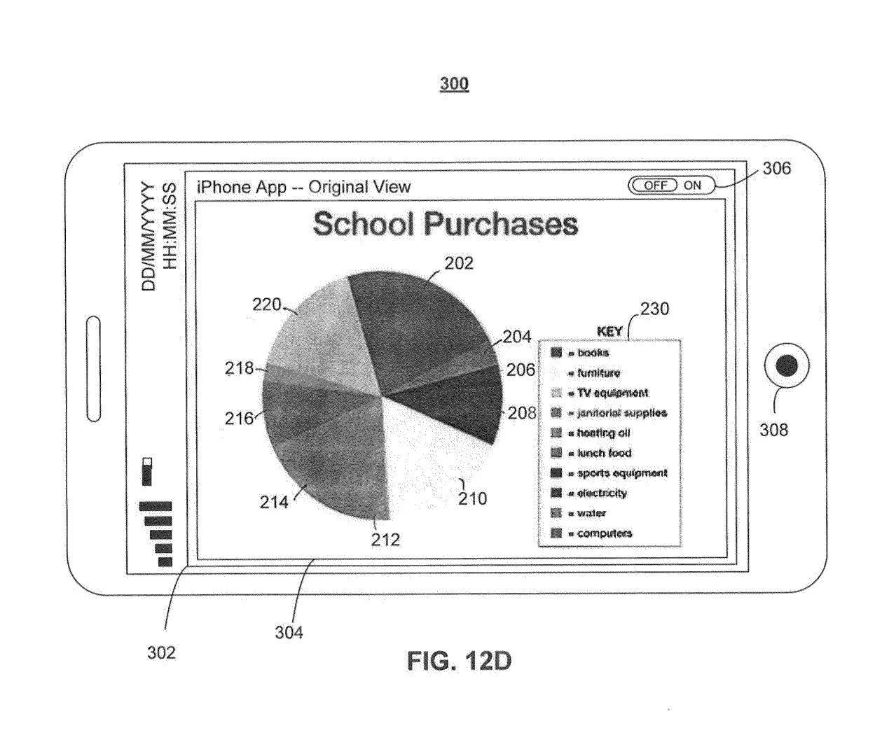

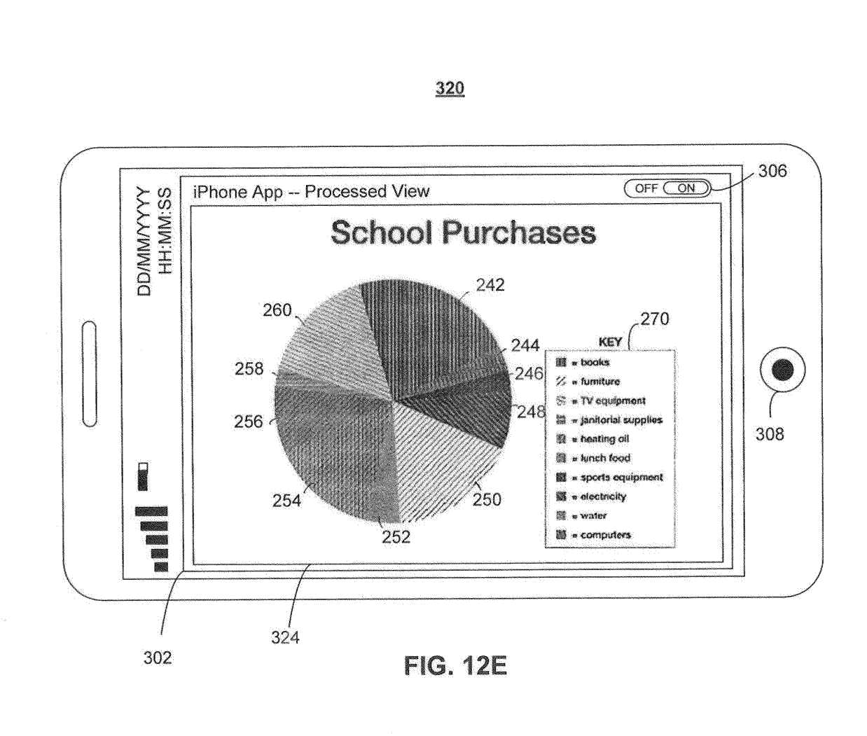

FIGS. 12A-12C depict an example of a process for encoding color information into a format detectable by a color blind user, according to an illustrative embodiment. FIG. 12A depicts an original pie chart 200. The wedges of the pie chart are depicted in various colors. For example, a first wedge 202 is red, a second wedge 204 is pink, a third wedge 206 is brown, a fourth wedge 208 is blue, a fifth wedge 210 is yellow, a sixth wedge 212 is grey, a seventh wedge 214 is orange, an eighth wedge 216 is tan, a ninth wedge 218 is green, and a tenth wedge 220 is turquoise. A viewer who is able to distinguish between the various colors can use the key 230 to determine that the seventh wedge 214 represents “heating oil.” However a color-blind person may have difficulty determining whether the seventh wedge 214 represents computers (wedge 204), water (wedge 212), heating oil (wedge 214), or janitorial supplies (wedge 218), since all of these wedges appear to be similar shades of grey. Furthermore, a color-blind person may have difficulty distinguishing the sixth wedge 212 from the seventh wedge 214.

FIG. 12B depicts a modified pie chart 240, which is a modified version of the pie chart 200 of FIG. 12A after it has been processed to encode the color information in striped textures. In the modified pie chart 240, a pattern has been added to each of the colored wedges 242, 244, 246, 248, 250, 254, 256, 258, and 260 of the pie chart, and an identical pattern has been added to the corresponding color blocks in the key 270. Note that the sixth wedge 252 is grey, as the sixth wedge 212 in the original pie chart 200 was grey, and therefore no pattern was added to the sixth wedge 252. The process adds a pattern to colored areas that is consistent, unique to each color and clearly distinguishable. Additionally, according to the process, the original color may show through the pattern. While a variety of different patterns could be used, in the illustrative example of FIG. 12B, the pattern consists of stripes composed of a 1 pixel-wide black line, a 1 pixel-wide white line, and a four pixel-wide transparent line through which the underlying color appears unchanged. Alternatively, the stripes may be dashed lines, dotted lines, or any other suitable linear pattern, including stripes of a larger hatch pattern such as dots, waves and so forth, and any combination of linear patterns may be used for the white, black, and transparent stripes. Note that the modified pie chart 240 enables any viewer to distinguish between the various wedges.

The process depicted in FIGS. 12A-12B includes determining the angle of the stripes used to encode the color information. First an operational color space is established, comprising at least three hue or color components. Under this method there is no limit to the number of hue or color components that may be used. The colored area is analyzed to determine the hue or color components, which in this example will comprise at least one and at most two of the following: red, yellow, green, cyan, blue, and magenta. Each of these hue components has an associated pattern of stripes, which also may be distinguished by angle. According to the illustrative embodiment of FIG. 12C, the red component R is associated with stripes at an angle 280 of 0 degrees, the yellow component is associated with stripes at an angle 282 of 30 degrees, the green component is associated with stripes at an angle 284 at 60 degrees, the cyan component is associated with stripes at an angle 286 of 90 degrees, the blue component is associated with stripes at an angle 288 of 120 degrees, and the magenta component is associated with an angle 290 at 150 degrees. Alternatively, according to another example, the red component is associated with vertical stripes, with an angle at 0 degrees, the yellow component is associated with stripes at a 45 degree angle, the green component is associated with stripes at a 90 degree angle, the cyan component is associated with stripes at a 112 degree angle, the blue component is associated with stripes at a 135 degree angle, and the magenta component is associated with stripes at a 158 degree angle. Because each colored area is comprised of at most two of the six hue components listed above, colored areas may be represented by cross-hatched textures comprised of two sets of intersecting stripes drawn at the unique angles associated with each of the two hue components.

Additional information regarding the strength of the hue component is encoded in the density of the stripe overlay. For example, for a bright, solid color, the stripes are fully visible, with the black portion of the stripe black, and the white portion of the stripe white. However, if the color is less saturated, the stripes are less visible, with the black and white portions appearing as shades of gray or transparency. For a combined color, more than one set of stripes will be superimposed. For example, orange is composed of a red component and a yellow component; it could thus be encoded by two sets of superimposed stripes, one set at 0 degrees and one set at 45 degrees. Shades of gray (including black and white) do not have a hue component, so they are not encoded with stripes. Thus, low-saturation backgrounds will remain muted, and most text-being white or black-will be unchanged and legible. Note that the process of encoding color information also allows for effective differentiation between colors for any monochromatic output (e.g. gray-scale laser printouts or faxes).

The patterns may reside in memory as fixed bitmaps which are differentially revealed, pixel by pixel in direct proportion to the hue of the pixel “above” them, allowing for maximum speed of display and simplicity of programming. This would allow images containing continuously varying hues to be displayed as easily and as rapidly as images with solid color areas.

In one embodiment, the process for encoding color information can be realized as a software component installed on a computer system or electronic imaging device, such as a digital camera or cell phone camera. In that embodiment, the process for encoding color information can be implemented as a computer program. The program can include a color encoding “window”, which can be manipulated by the user to, for example, change its size or its location on the display. When the window is positioned over a portion of the displayed image, that image portion is color encoded such that a unique pattern is associated with each colored area, as described above. The window can be any size chosen by the user, including covering the entire display and any portion of the display.

FIGS. 12D-12E depict an example of a mobile device that processes color information into a format detectable by a color blind user, according to an illustrative embodiment. The mobile device may have a software component installed for encoding color information. The mobile device may receive input images from an on-board camera, a network (e.g., the Internet), or a connected storage device. In some embodiments, the mobile device may be an iPhone® manufactured by Apple, Inc. of Cupertino, Calif., or a similar mobile device. In such embodiments, a software application configured to run on an iPhone® may be provided such that the application processes color information into a format detectable by a color blind user. The software application may implement the process for encoding color information as described above with reference to FIGS. 12A-12C. In some embodiments, the software application may encode color information in real-time. For example, as the user moves an on-board camera on the iPhone® or similar mobile device over different portions of an image, the image portion under focus of the camera at a given time may be processed for a color blind user. Such real-time processing of images is sometimes known as augmented reality. In such systems, a live view of a real-world environment may be augmented by computer-generated graphics. Further details are provided below with reference to FIG. 12E.

FIG. 12D depicts a view 300 of a mobile device having a software application configured to run on an iPhone®, or a similar software component, installed for processing color information. The mobile device has a touch screen 302 displaying software component 304 as it is being executed. A user may interact with software component 304 via touch screen 302 or button 308. For example, the user may take a picture of the pie chart depicted in FIG. 12A using a camera on-board on the mobile device. As described above with reference to FIG. 12A, the original view of the pie chart has wedges depicted in various colors. For example, a first wedge 202 is red, a second wedge 204 is pink, a third wedge 206 is brown, a fourth wedge 208 is blue, a fifth wedge 210 is yellow, a sixth wedge 212 is grey, a seventh wedge 214 is orange, an eighth wedge 216 is tan, a ninth wedge 218 is green, and a tenth wedge 220 is turquoise. A user who is able to distinguish between the various colors can use the key 230 to determine that the seventh wedge 214 represents “heating oil”. However a color-blind person may have difficulty determining whether the seventh wedge 214 represents computers (wedge 204), water (wedge 212), heating oil (wedge 214), or janitorial supplies (wedge 218), since all of these wedges appear to be similar shades of grey. The user may flip switch 306 to turn on the color information encoding feature of software component 304. The original view of the pie chart is then processed for color information and outputs the pie chart discussed with reference to FIG. 12E below.

FIG. 12E depicts a view 320 of the mobile device having a software component installed for processing color information. Once the color information encoding feature of software component 304 is turned on, the system processes the color information in the pie chart to encode the color information in striped textures. In the processed view of the pie chart, software component 304 adds patterns to each of the colored wedges 242, 244, 246, 248, 250, 254, 256, 258, and adds identical patterns to the corresponding color blocks in the key 270. Software component 304 adds a pattern to colored areas that is consistent, unique to each color and clearly distinguishable. In some embodiments, the original color may show through the added pattern. The patterns in this illustrative example consist of stripes composed of a 1 pixel-wide black line, a 1 pixel-wide white line, and a four pixel-wide transparent line through which the underlying color appears unchanged. Alternatively, the stripes may be dashed lines, dotted lines, or any other suitable linear pattern, including stripes of a larger hatch pattern such as dots, waves and so forth, and any combination of linear patterns may be used for the white, black, and transparent stripes. In other embodiments, different patterns or visual indicators may be used based on the hue components of the colors. In this manner, software component 304 installed on the mobile device enables any viewer to distinguish between the various wedges of the pie chart.

Other examples of color images that may be processed for a color blind user include bar charts, flowcharts, financial charts, scatter charts, weather maps, traffic maps, subway maps, cell phone coverage maps, complex maps, colored text, catalog illustrations, graphic arts, engineering drawings, and other suitable color images that may be troublesome for a color blind user. In some embodiments, the software component (e.g., software component 304 described above) may isolate all instances of a selected color in an image and gray out other colors in the image.

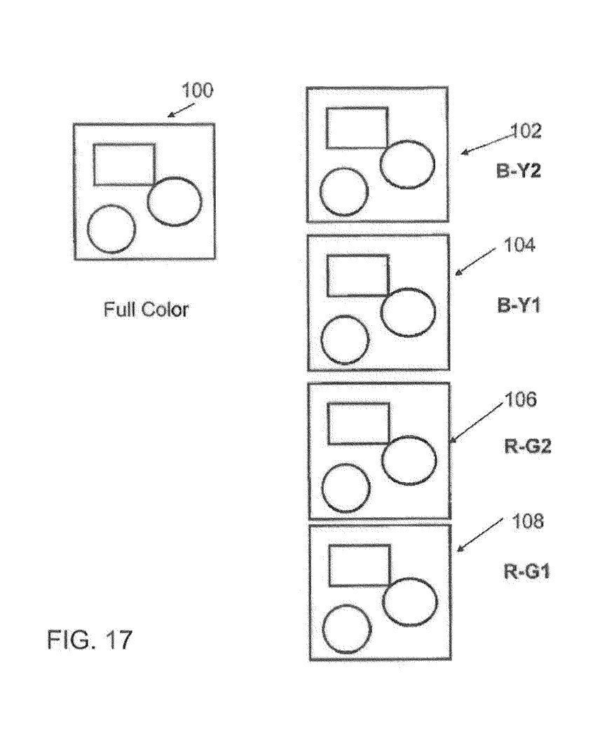

Such approaches are described further below with reference to FIG. 17. In some embodiments, the software component may flash all portions of an image having the selected color. The color may be chosen in the image or from a color name list presented to the user. While flashing, all instances of the selected color may be converted to another color easily distinguishable by a color blind user, e.g., black, white, or another suitable color. Such approaches are described further above with reference to FIGS. 7-9. Any or all of the approaches discussed above may be realized in the software component configured to run on a mobile device.

Though the mobile device is shown in a portrait orientation in FIGS. 12D and 12E, the mobile device may process color information of an image in any position that is convenient for the user. In some embodiments, the mobile device may process the color information of the image in real-time. For example, as the user moves the camera of the mobile device over different portions of an image, the image portion under focus of the camera at a given time may be processed for a color blind user in a manner described above. Such real-time processing of images is sometimes known as augmented reality. In such an example, a live view of a real-world environment (e.g., the pie chart) is augmented by computer-generated graphics (e.g., patterns on colored wedges of the pie chart).

In some embodiments, software component 304 may include a color encoding “window”, which receives input images from an on-board camera, the Internet, or a connected storage device. The window may be manipulated by the user to, for example, change its size or its location on the screen 302. When the window is positioned over a portion of the displayed image, and switch 306 is flipped to ON, that image portion is color encoded such that a unique pattern is associated with each colored area, as described above. In some embodiments, software component 304 may process the displayed image automatically without need for user input to flip switch 306. For example, software component 304 may process the displayed image after a user focuses on the image for a fixed period of time. In some embodiments, software component 304 may only encode colors with patterns that are troublesome to the user. For example, a user having red-green color blindness may only have the software component encode colors related to his color blindness condition. In order to aid the user, software component 304 may include an initiation test that allows the user to identify the type of color blindness that the user has. Such a feature is further discussed in the description that follows below.

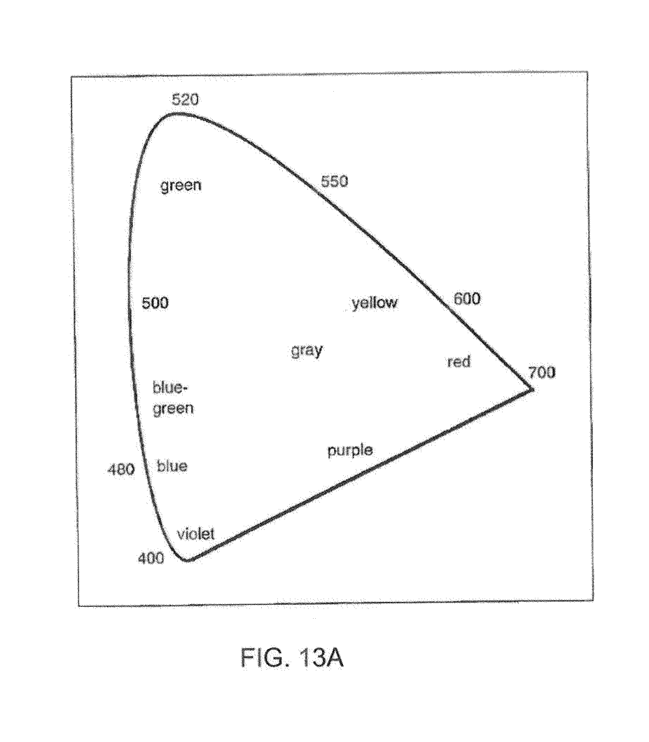

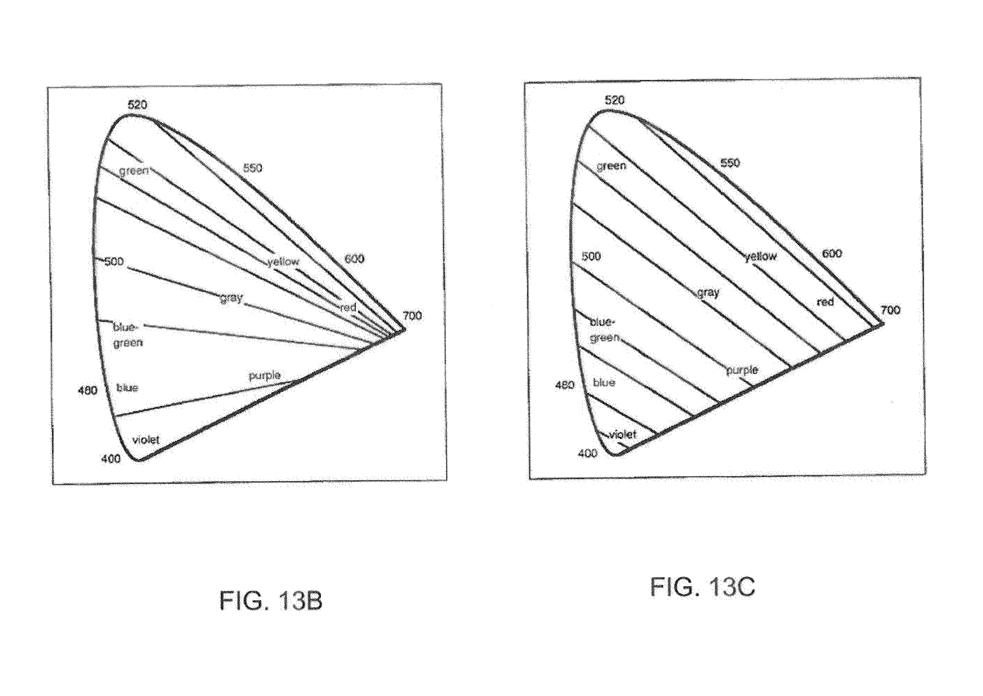

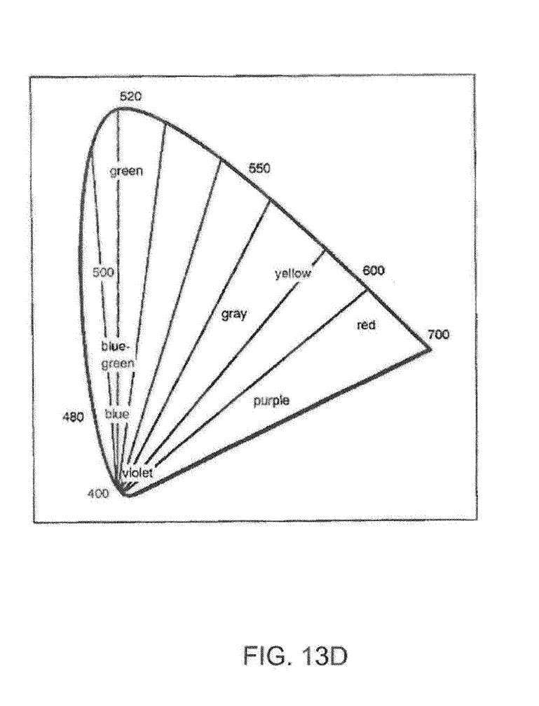

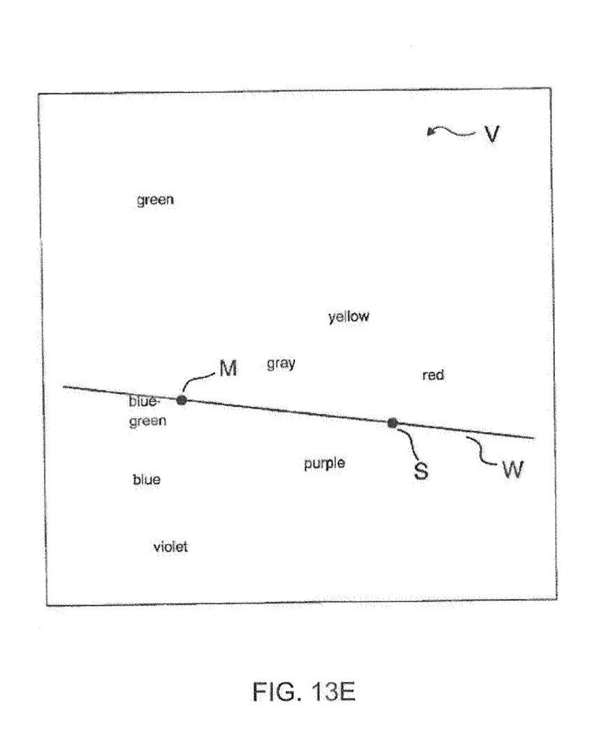

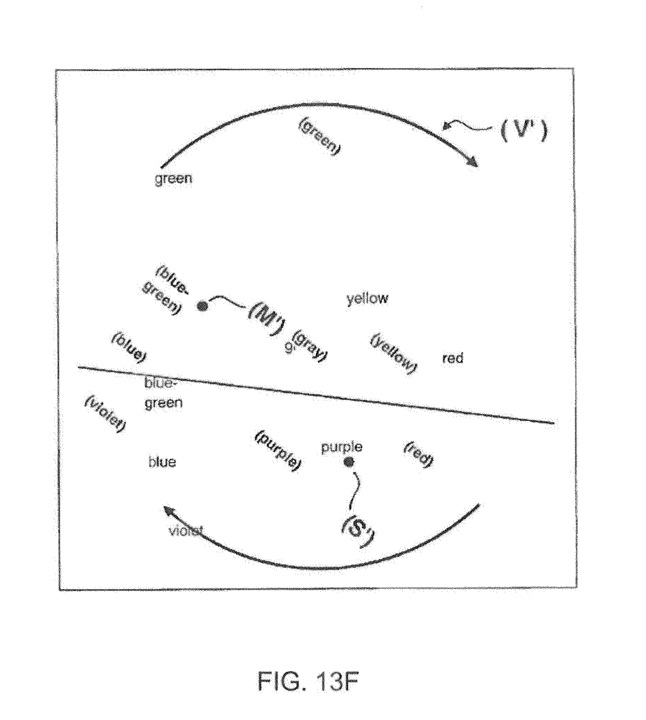

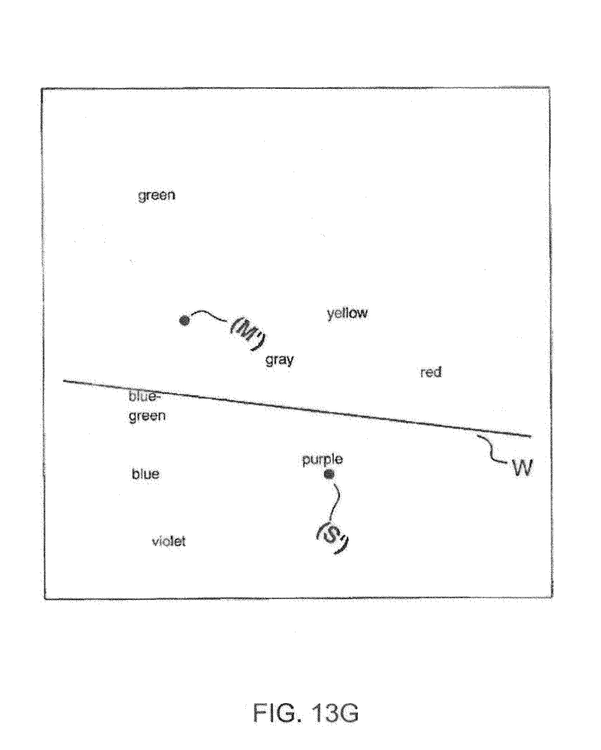

Hue Rotation as an Aid to Color Perception FIG. 13A is a commonly understood diagram of normal color space: the C.I.E. chromaticity diagram (1931). In this representation, there is only hue and saturation shown, not lightness/darkness (value). In this respect, it is similar to the a circular hue plane in the HSL color space as well as to the rectangular AB plane in the LAB color space. A normally sighted person can differentiate between all the colors represented in this diagram.

In terms of this color space representation, as shown in FIGS. 13B, 13C, and 13D, for different color blind persons there are different lines of “color confusion” or “isochromatic lines.” Colors that lie on one of these lines or vectors cannot be differentiated one from another.

Different forms of color blindness have different lines or vectors of color confusion. FIG. 13B represents one form of protanopia, FIG. 13C represents one form of deutanopia, and FIG. 13D represents one form of tritanopia.

According to the literature, there seems to be not just a few, but rather many variations in these lines or vectors of color confusion among color blind people. It is difficult or impossible to choose one or even a few solutions for color display modifications that will work for all color blind people, even those nominally of the same type.

In a computer with a color display, a computer program will call for colors defined typically in an RGB color space to be displayed on a monitor, which again, typically, requires R, G, and B values. In a device in accordance with the systems and methods described herein, an intermediary color space is interposed on which the colors called for by the computer's program are mapped. This intermediary color space may be an RGB space, a CIE space, an HSL space, an LAB space, a CMYK space, a pseudo color space in which different colors are represented by different hatching patterns, or any other color space. The colors of this intermediate color space are in turn remapped onto the RGB values utilized by the display or printer output.

It can be seen that if the intermediate color space and the display color space are rotated in relation to each other, then when the computer program calls for a certain specific color to be output on the computer's display, another specific color will be displayed. Rotating these color spaces in relation to each other will thus re-map the input colors onto another set of colors.

For a color blind user, if there are two colors that both lie on one line or vector of color confusion, then rotating the intermediate color space may well result in two different colors that now do not lie on the same vector of color confusion and thus can now be successfully differentiated one from another.

What this means is that if there are two objects that are displayed on a computer monitor and the colors that render these two objects are such that a certain color blind person cannot tell them apart, then rotating the intermediate color space in relation to the display color space may now make the two objects look different (i.e. able to be differentiated from each other) to the color blind person. Because there are so many different forms of color blindness, giving the computer user the ability to rotate the color spaces him or herself will give the computer user the ability to find the exact setting that lets them do the best job of differentiating between the colors in each computer image or window in question.

When trying to differentiate between different color areas in a complex or subtle image on a computer display, even a normally-sighted person might find the systems and methods described herein useful.

Accordingly, in alternative embodiments, the systems and methods described herein employ a color space rotation process to remap color-coded information from one portion of the color space to another portion of the color space. As shown in FIG. 13E, in an intermediate color space V, there are two colors M and S that a computer program is causing to be displayed on the computer monitor. Color M is blue-green hue and color S is a reddish-purple hue. These two hues both lie on a vector W of color confusion of a certain color blind person. Therefore, on the computer monitor, the hues of these two colors M and S look the same to the color blind person.

As shown in FIG. 13F, if using a device according to the systems and methods described herein the color blind person rotates the hues of the intermediate color space V to a new orientation V′, then hues are remapped such that the two colors actually displayed on the computer's monitor have hues and M′ and S′.

As show in FIG. 13G, with this remapping, M′ will be displayed as a “yellower” green and S′ will be displayed as a “bluer” purple. Note that these two hues do not lie on the color blind person's vector of confusion W. This means that the person will now be able to successfully discriminate between the two colors.

Thus, the systems and methods described herein can rotate the color space so that colors used to express information in an image are moved off a line of confusion for the user. This process moves colors into the perceptual space of the user. In optional embodiments the system can remap colors on the line of confusion to different locations that are off the confusion lines. This can be done by rotating the line or by substitution of colors on the line W, for colors that are not on the line W. In this practice, the system can identify colors in a color space that are absent form the image and which are not on the line W may be substituted for colors on the line W. In this way colors on the line W used to present information may be moved off the line and remapped to a color in the perceptual space of the user and not currently being used in the image.

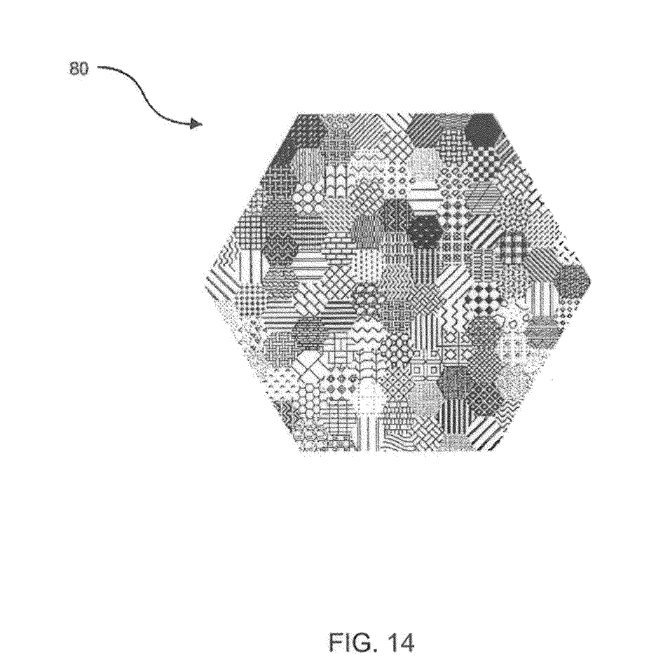

As discussed above, FIG. 14 depicts a color space that is a pseudo color space 80 where different colors are represented by different hatching patterns. Color space 80 may act as the intermediate color space described above. In this case, a pixel color value in the original color space called for by the program can be mapped to a region in color space 80 that has a respective hatch pattern. Thus, in this embodiment a selected range of colors from the first color space are mapped to a specific region of this intermediate color space 80. This selected range of colors are identified as a contiguous area or areas as appropriate in the original image and filled with the respective hatching pattern associated with that selected range of colors. In this way the output presented to the user either on the display or in printer output—including a black and white printer's output—can more clearly differentiate between different color-coded data. Thus, the color space 80 may be a perceptual space for the user, and colors may be mapped to this perceptual space.

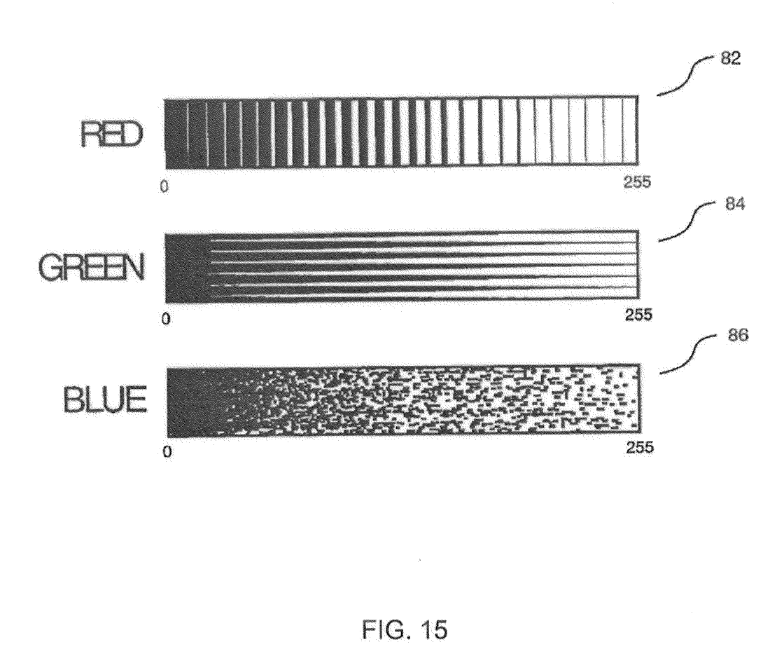

In an alternate practice, color information can be mapped into a composite hatching pattern by assigning each component of the color, such as red green and blue, its own hatching pattern. For example, FIG. 15 depicts the three color components of an RGB defined color space. Figure three further shows that each of the components is assigned its own hatching pattern. For example color component red is assigned the hatching pattern 82. As shown, the hatching pattern 82 comprises a set of vertical lines where the line density decreases as the red value increases from 0 to 255. Thus a red color component having a know value such as 100 can be associated with a specific line density. Similar hatching patterns have been assigned to the green 84 and blue 86 components.

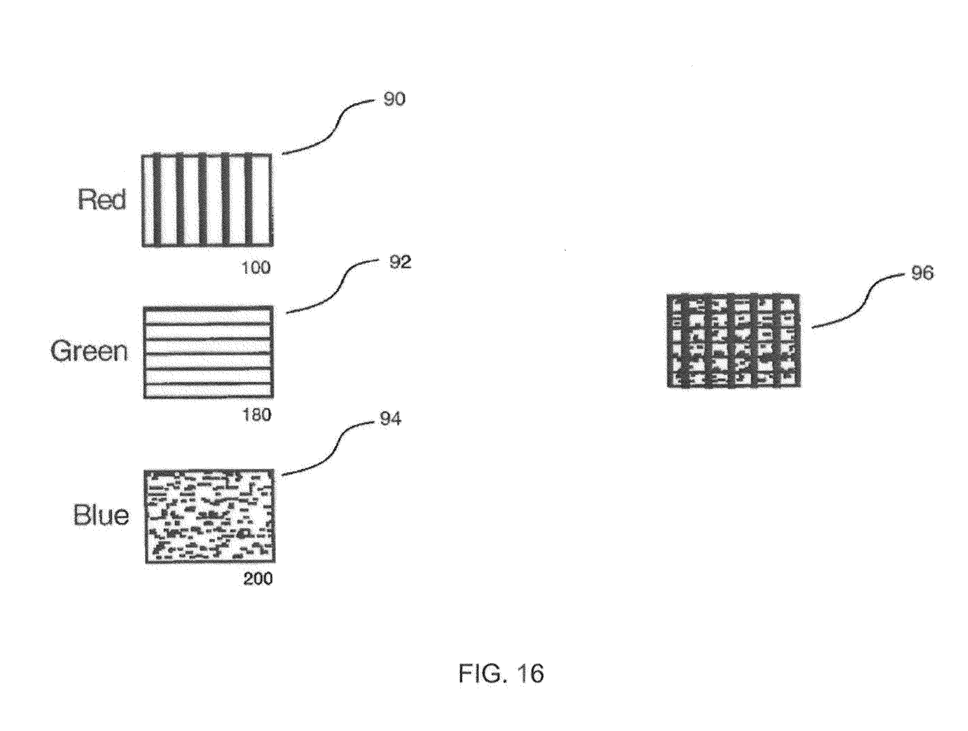

As shown in FIG. 16 a light greenish blue color which is defined in an RGB color space as having component values of R-100, G-180 and B-200 are assigned their associated hatching pattern. When these three hatching patterns are superimposed one on the other, a unique combined pattern will be created on the display or output. For example FIG. 16 depicts a composite pattern 96 formed from the superimposition of the patterns 90, 92 and 94. In other color spaces, there may be more or less than three associated hatching patterns. For example, a CMYK color space would have four hatching patterns, one pattern for each component of the CMYK color space.

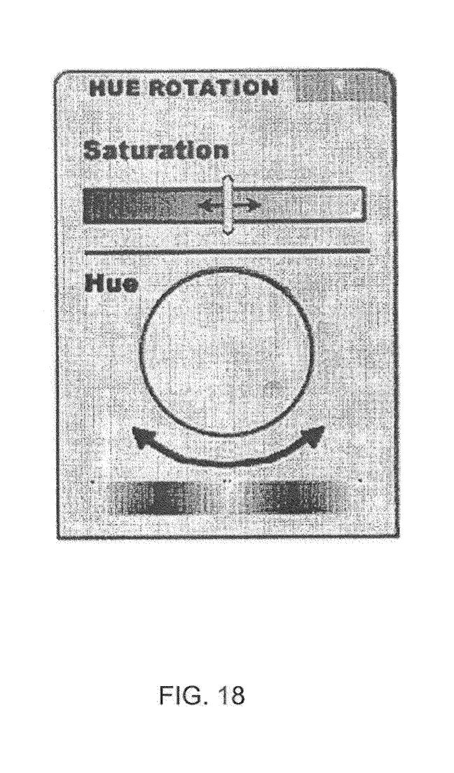

One user interface that would be helpful would be a representation of a wheel or disk that is turned to rotate the intermediate color space and output color space in relation to each other. The wheel or disk that is turned to rotate the two hue maps in relation with each other. One such wheel is depicted in FIG. 18. There could also be a representation of a slider for the user to use in adjusting the saturation of the image. Especially if this control were configured such that increasing or decreasing the saturation of a image were to effect preferentially the areas of the image that have a color tone (as opposed to being essentially neutral or gray), the feature would further help the user in refining the color manipulation so as to better discern differences between different colored areas.

The systems described herein may employ the operating system API to control the display of colors on the computer display. Generally, an API provides a set of mathematical functions, commands and routines that are used when an application requests the execution of a low-level service that is provided by an OS. APIs differ depending on the OS types involved. A video system is employed to handle the output provided for a display unit. By applying VGA, SVGA or other appropriate standards, a video system determines how data is to be displayed and then converts digital signals of display data into analog signals to transmit to a display unit. It also determines what the refresh rate and standards of a dedicated graphics processor and then converts character and color data, received from an API as digital signals of display data, into analog signals that is thereafter transmitted to a display unit. As a result, predetermined characteristics are displayed on a screen.

A video system has two general display modes: a graphics mode and a text mode. The systems and methods described herein may be practiced in either mode. The graphics mode, however, is today the most important mode, and in this mode, data that are written in a video memory for display on a screen are handled as dot data. For example, for a graphics mode that is used to display 16 colors, in the video memory one dot on the screen is represented by four bits. Furthermore, an assembly of color data, which collectively is called a color palette, is used to represent colors, the qualities of which, when displayed on a screen, are determined by their red (R), green (G) and blue (B) element contents. Generally, in an eight bit mode, when the color combination represented by (R, G, B)=(255, 255, 255) is used, a white dot appears on the screen. Whereas, to display a black dot on a screen, a color combination represented by (R, G, B)=(0, 0, 0) is employed (hereinafter, unless otherwise specifically defined, the color elements are represented as (R, G, B)). An OS reads the color data designated by the color pallet and the character data (character code, characters and pictures uniquely defined by a user, sign characters, special characters, symbol codes, etc.), and on a screen displays characters using predetermined colors.

In one embodiment, this process described above is implemented as a software driver that processes the RGB data and drives the video display. In one embodiment, the software driver also monitors the position of the cursor as the cursor moves across the display. The driver detects the location of the cursor. If the cursor is over a portion of the screen that includes a color table, the software process determines the color under the cursor. To this end, the driver can determine the location of the cursor and the RGB value of the video data “under” the cursor. Thus the color that the cursor is “selecting” can be determined. The driver then processes the display in a manner such that any other pixel on that display having a color (RGB value) that is identical to the color, or some in cases substantially identical or within a selected range, is reprocessed to another color (black, white, or greys) in the color map. This results in an alternate image on the display. By having the driver reprocess the color in a way that is more perceptible to a color blind person, the color coded information in the image can be made more apparent to the color blind user. This is shown in FIG. 11 wherein the cursor is depicted over a portion of the key table and the portion of the pie chart having the same color as that portion of the key table is processed to change brightness over time. In this way a colorblind person can operate a mouse to relate the different sections of the pie charts to the key table and the information that section of the pie chart is intended to represent. At described above the system may be implemented as a video driver process. However, in alternate embodiments the system may be implemented as part of the operating system, as part of the application program, or as a plug-in, such as a plug-in that can execute with the Internet Explorer web browser. It would be understood that the systems and methods designed herein can be adapted to run on embedded systems including cell phone, PDAs, color displays of CNC or other industrial machines, game consoles, settop boxes, HDTV sets, lab equipment, digital cameras, and devices. As illustrated in these examples, embedded systems may include mobile or portable devices. In certain embodiments, the systems and methods described herein can alter the entire display, however, in other embodiments, such as those that work with a windows based display systems, such as X windows, only the active window will be effected, and optionally, each window may be effected and altered independently.

### Changing of Color of Background-Non-Selected Colors to Another Color Code

The manner in which the RGB values are processed can vary according to the application, and optionally may be user selectable. For example, in one embodiment, the driver may process the image to cause colors other than the selected range to turn more gray. Optionally, those portions of the image that are not presented in the selected color may be presented in a black and white image. In a further optional embodiment, the system may alter the saturation of the display, such that portions of the image that are not presented in the selected color will fade to become less saturated. In a further practice, the system allows the user to lighten or darken the grayed out portions of the image and/or alter the contrast of the grayed out portion of the image.

In a further embodiment, the systems and methods described herein may began with an initiation test that allows a color blind user to identify to the system the type of color blindness that the user has. To this end, and as depicted in FIG. 17, a display is presented to the user. On the display is a full color image 100 and a plurality of images 102, 104, 106 and 108 each of which presents a processed version of the full color image. These processed versions of the full color image are made by reducing a full color image from a three color space to a two color space and correspond to different types of color blindness. For example, the first image may present a particular kind of red and green color blindness, shown as RG1, and another image may present a different kind of red and green color blindness, shown as RG2, or as a version of blue and yellow (BY) color blindness. In either case the multiple images may be presented to the user and the user is allowed to select which of the images most closely matches the appearance of the full color image to the user. Once this information is provided to the system, the system may select the algorithm for processing the red, green and blue color values associated with the image being displayed to the user.

The user may also have control over how the image is represented, such as what and how many colors are processed, whether the processed colors are shown as getting darker or lighter, whether the colors flash or transition slowly, whether the colors are represented as having texture, like a hatch pattern, and other user controls. The application program can be PowerPoint, a web browser that uses color to show changes in the activation-status of hyperlinks, map displays, or some other program.

In a further alternative, the systems and methods described herein provide for treating color blindness. To this end, the systems and methods described herein include, in one embodiment, a computer game that may be played by males between the ages of six and fifteen. The computer game presents a series of images to the player. The player is asked to distinguish between different images and makes decisions based on his perception of these images. In this example game, the player is presented with two objects colored with two colors that the color blind person has difficulty in distinguishing. The player is rewarded for quickly tagging, in this example, the red object. However the player is penalized for tagging the wrong color object, in this case green. After a certain short time delay, the red, preferred target is identified to the player by overlaying a black texture that does not change the underlying color. The player can then tag the correct object for a lower score. In this way, the color blind player is encouraged to closely observe two colors he normally has difficulty in distinguishing and then have one color identified. Over time, as data is collected on the player, the game can be modified to make differentiation more challenging, such as by employing more subtle colors or presenting only one object at a time. By this game, the color blind player is given the tools to improve his ability to distinguish colors.

Although not to be limited by theory, it is a realization of the inventors that at least a portion color blindness arises from a central nervous system failure to allow a user to distinguish between different colors. Accordingly, the systems and methods described herein require the user to train their CNS system to detect a broader range of colors.

The systems and methods discussed above may be realized as a software component operating on a conventional data processing system such as a Windows, Apple or Unix workstation. In that embodiment, these mechanisms can be implemented as a C language computer program, or a computer program written in any high level language including C++, Fortran, Java or basic. Additionally, in an embodiment where microcontrollers or DSPs are employed, these systems and methods may be realized as a computer program written in microcode or written in a high level language and compiled down to microcode that can be executed on the platform employed. The development of such image processing systems is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing (1983). It is noted that DSPs are particularly suited for implementing signal processing functions, including preprocessing functions such as image enhancement through adjustments in contrast, edge definition and brightness. Developing code for the DSP and microcontroller systems follows from principles well known in the art.

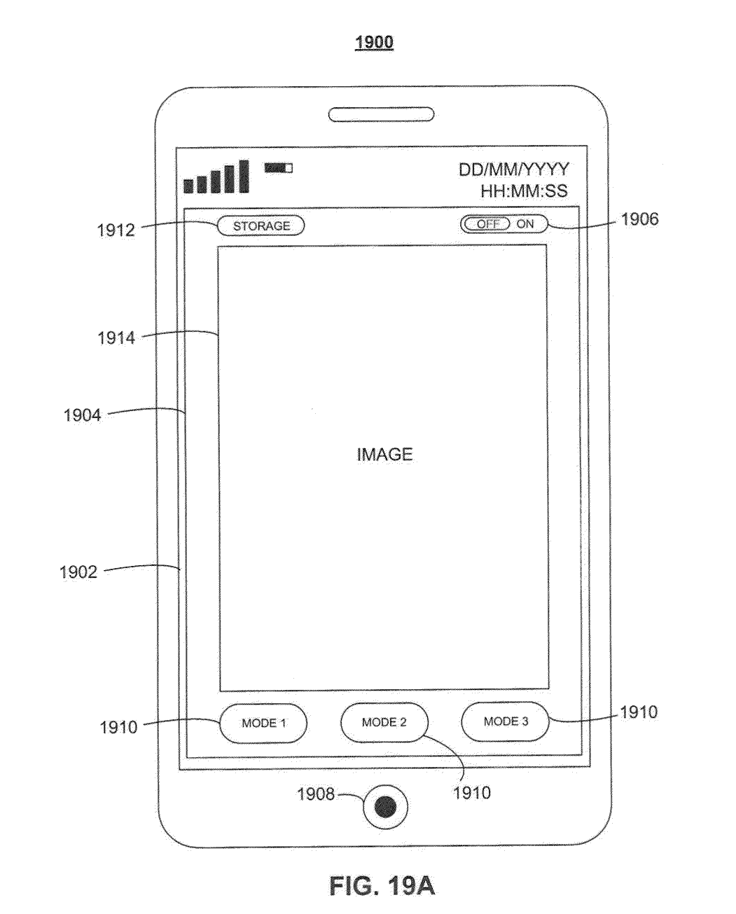

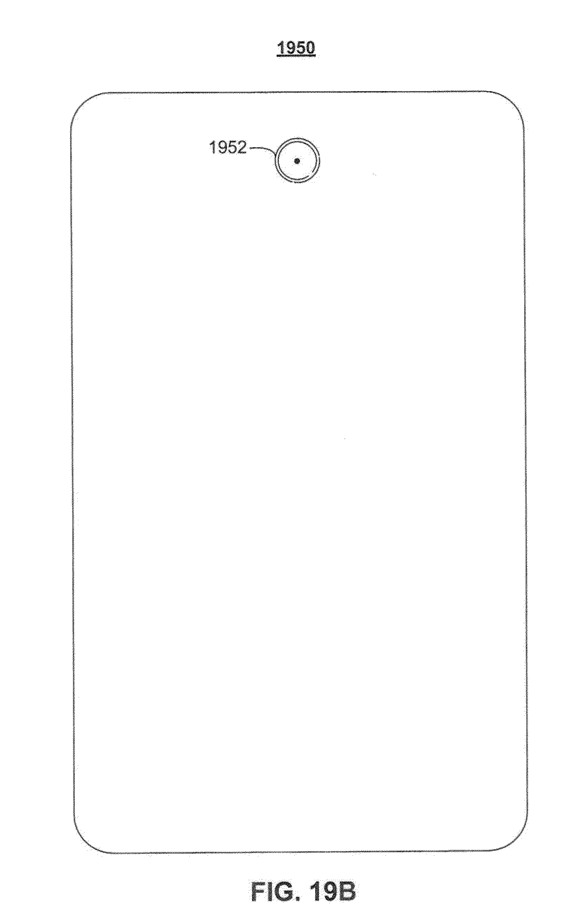

In some embodiments, any or all of the systems and methods discussed above may be realized as a software component on a mobile or portable device, such as the iPhone®manufactured by Apple, Inc. of Cupertino, Calif. FIGS. 12D and 12E depict an exemplary embodiment of such a software component implemented on a mobile device. In some embodiments, the software component may include any or all of the systems and methods discussed above for processing an image for a color blind user. The software component may be realized on an embodiment of a mobile device as further discussed below with reference to FIGS. 19A and 19B.

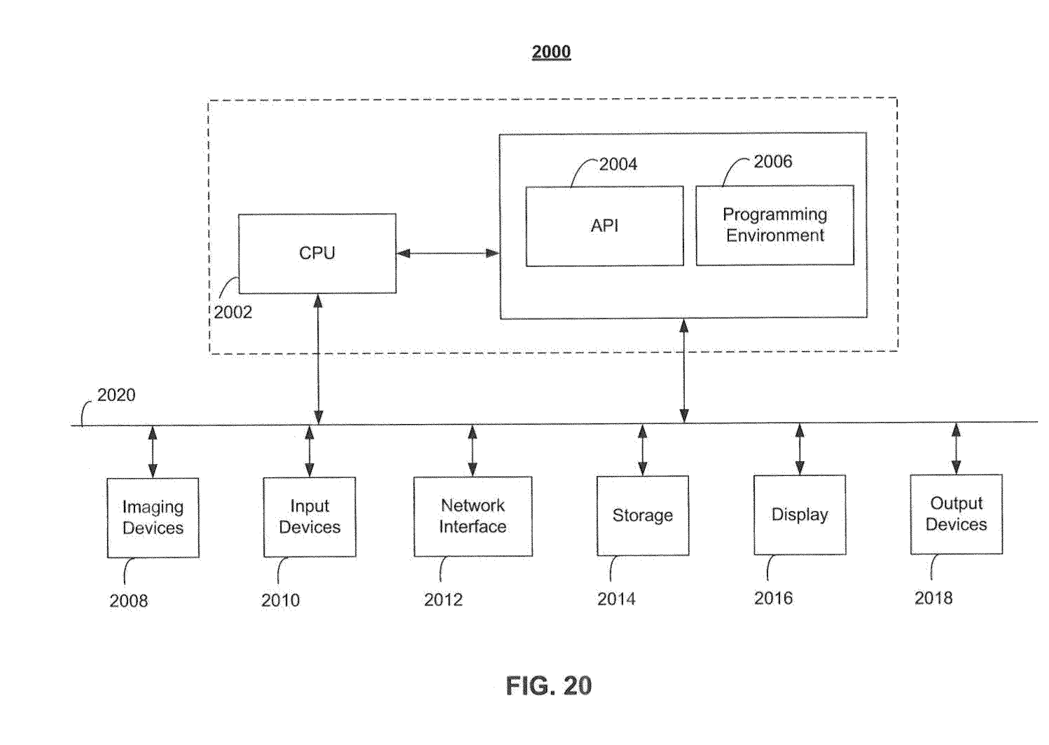

FIGS. 19A and 19B depict illustrative embodiments of a front view 1900 and a back view 1950 of a mobile device having a software component installed for processing color information. The mobile device has a screen 1902 displaying software component 1904 as it is being executed. Software component 1904 may be implemented as part of the operating system, as part of an application program, or as a plug-in, such as a plug-in that can execute with the Internet Explorer® web browser distributed by Microsoft Corp. of Redmond, Wash. A user may interact with software component 1904 via screen 1902 having touch capabilities, button 1908, a physical keyboard, or suitable user input device. The mobile device has an on-board camera 1952 placed on the back panel. In some embodiments, more than one camera may be included in the mobile device. The cameras may be placed at suitable locations on the front or back panels of the mobile device. In some embodiments, the camera may be a wireless camera connected wirelessly to the mobile device, and supplying images over the wireless connection. The mobile device may include a processor, memory, storage, network interface, and other suitable system components. Further details on the system components of an embodiment of the mobile device are provided with reference to FIG. 20.

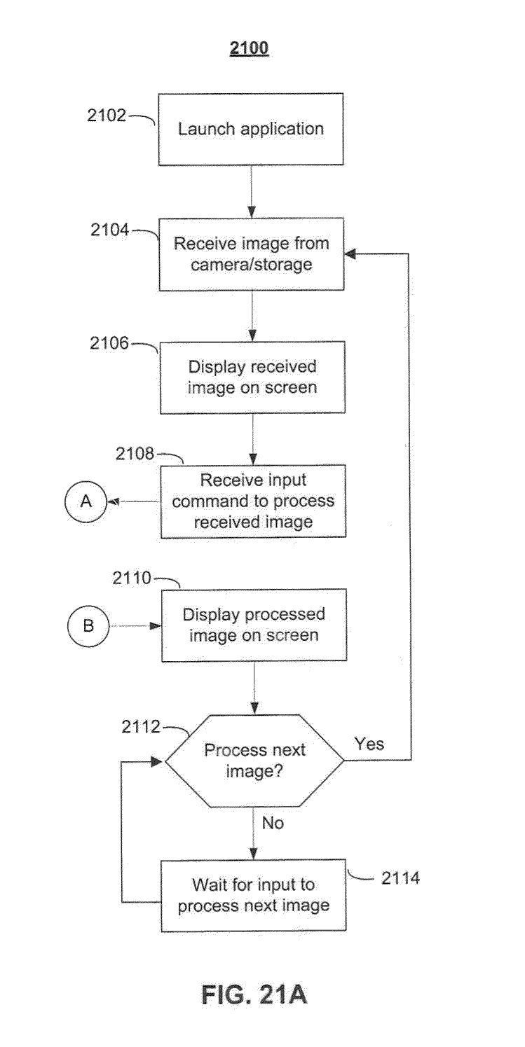

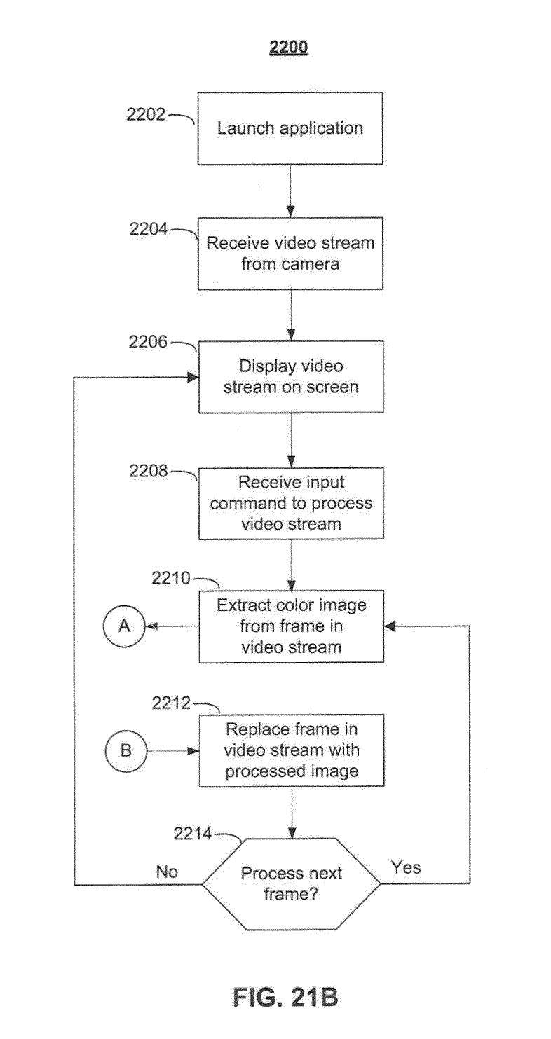

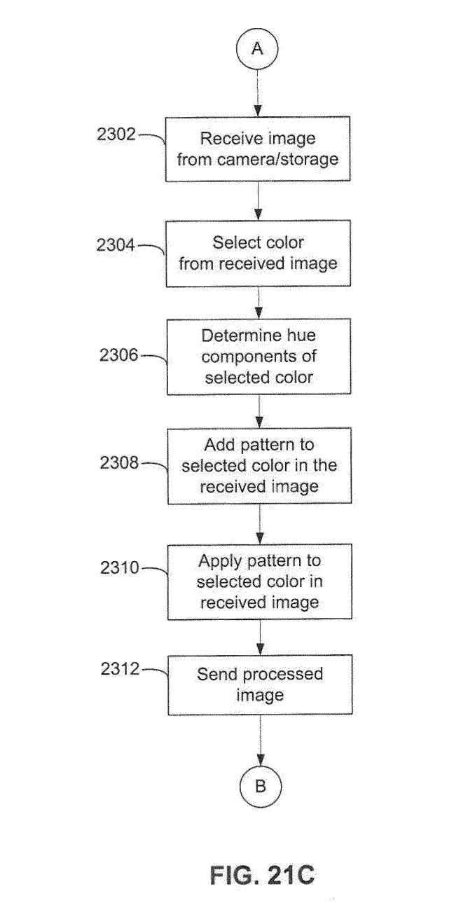

Software component 1904 may allow a user to choose from one or more available modes of operation 1910. In some embodiments, software component 1904 may allow a user to capture an image using on-board camera 1952 and display the captured image on the screen in image window 1914. In some embodiments, the user may push storage button 1912 and retrieve an image stored on the mobile device or a network connected to the mobile device. The user may flip switch 1906 to the ON position to initiate processing color information in the image suitable for a color-blind person. In some embodiments, flipping switch 1906 to the ON position may launch an initiation test for the user to identify the type of color blindness that the user has, as described above with reference to FIG. 17. Software component 1904 may process the colors in the image based on the information from the initiation test. Software component 1904 may process and display the processed image in image window 1914. Software component 1904 may wait for the user to capture another image from the on-board camera 1952, or switch to another mode of operation. Further details on the above embodiments are provided with respect to FIG. 21A.

In some embodiments, software component 1904 may allow a user to view and/or capture a video stream, e.g., a live video feed, using on-board camera 1952. The video stream may be displayed in image window 1914. The user may flip switch 1906 to the ON position to initiate real-time processing of the video stream suitable for a color-blind user. Software component 1904 may extract an image frame from the video stream, process the color image frame, and replace the frame in the video stream with the processed image frame. The processed video stream may be displayed in image window 1914. In some embodiments, processing an image frame may include creating an overlay having patterns and/or visual indictors for displaying on top of the image frame in the video stream. For example, a frame may be captured by on-board camera 1952 and processed by software component 1904. However, instead of producing a processed image frame, software component 1904 may create an overlay having, e.g., patterns and/or visual indicators, for displaying on top of the image frame. Software component 1904 may display the image frame captured by camera 1952 along with the overlay in image window 1914. Further details on the above embodiments are provided with respect to FIG. 21B.

FIG. 20 depicts an illustrative block diagram of a of a mobile device 2000 having a software component installed for processing color information. As described above, exemplary embodiments of mobile device 2000 include embedded systems, cell phones, PDAs, game consoles, set-top boxes, digital cameras, HDTV sets, lab equipment, color displays on industrial machines, and other suitable devices. In some embodiments, mobile device 2000 may include a visor as described above with reference to FIGS. 1A-3. Mobile device 2000 includes a central processing unit (CPU) 2002, and internal memory having an API 2004 and/or any other suitable programming environment 2006. At least a portion of the software component may reside in internal memory. CPU 2002 may be in communication via bus 2020 with one or more imaging devices 2008, one or more input devices 2010, a network interface 2012, storage 2014, a display 2016, and one or more output devices 2018. Imaging devices 2008 may include an on-board camera, a wireless or wired camera, or any other suitable imaging device. Input devices 2010 may include a touch-capable screen, a keyboard, a mouse, a remote control, or any other suitable device. Network interface 2012 may include a cable modem, an integrated services digital network (ISDN) modem, a digital subscriber line (DSL) modem, a telephone modem, a wireless modem, a satellite receiver, a router, a wireless or wired modem, a cellular or satellite phone, or any other suitable equipment that allows for communication with a communications network, such as any suitable wired or wireless network. Storage 2014 may include any suitable fixed or removable storage devices, e.g., hard drives and optical drives, and include any suitable memory, e.g., random-access memory, read-only memory. Display 2016 may include any suitable display device, e.g., a LCD or plasma display. Output devices 2018 may include external memory or other peripheral devices that may be operable when connected to the mobile device via a wired or wireless connection. CPU 2002 may execute program instructions from the software component to process color information in an image. CPU 2002 may follow a process flow as described in relation to FIGS. 21A, 21B, and/or 21C below.

FIG. 21A depicts an illustrative embodiment of a process flow diagram 2100 for CPU 2002 executing a software component for processing colors in an image for a color-blind person. At 2102, CPU 2002 may initiate execution of the software component. At 2104, CPU 2002 receives an image from, e.g., a wireless camera, an on-board camera (such as camera 1952 in FIG. 19), or storage. At step 2106, CPU 2002 may optionally display the received image on the screen of the mobile device (e.g., screen 1902 in FIG. 19). At step 2108, CPU 2002 receives an input command to process the received image. In some embodiments, the input command may include a user flipping a switch (e.g., switch 1906 in FIG. 19). In some embodiments, the input command may be generated by CPU 2002 in response to the user focusing on a certain scene using the camera for a fixed period of time. CPU 2002 may process the colors in the image as further described with reference to FIG. 21 IC below. In still other embodiments, CPU 2002 begins to process the received image without an input command. At step 2110, CPU 2002 displays the processed image or a select portion of the process image on the screen. At step 2112, CPU 2002 may check whether the user would like to provide another image for processing. If so, CPU 2002 may proceed to step 2104. If not, CPU 2002 may wait at step 2114 for input from the user to proceed to the next image. In some embodiments, CPU 2002 may wait for a fixed period of time at step 2114 before proceeding to step 2104.

FIG. 21B depicts an illustrative embodiment of a process flow diagram 2200 for CPU 2002 executing a software component for processing colors in a video stream for a color-blind person. At 2202, CPU 2002 may initiate execution of the software component. At 2204, CPU 2002 may receive a video stream, e.g., a wireless camera, an on-board camera (such as camera 1952 in FIG. 19), or storage. The video stream may be a live video feed. At step 2206, CPU 2002 may optionally display the received video stream on the screen of the mobile device (e.g., screen 1902 in FIG. 19). At step 2208, CPU 2002 receives an input command to process the received image, e.g., a user flipping a switch (e.g., flipping switch 1906 to the ON position). At step 2210, CPU 2002 extracts an image frame from the video stream for processing. CPU 2002 may process the colors in the image frame as further described with reference to FIG. 21C below. At step 2212, CPU 2002 may receive a processed video frame and replace the corresponding frame in the video stream for display on the screen. At step 2214, CPU 2002 checks whether the user would like to continue processing the video stream. For example, CPU 2002 may check whether the user has flipped the switch again (e.g., flipped switch 1906 to the OFF position). If so, CPU 2002 proceeds to step 2206 and resume displaying the unaltered video stream. If not, CPU 2002 may proceed to step 2210 and continue processing the video stream. In some embodiments,

FIG. 21C depicts an illustrative embodiment of a process flow diagram 2300 for CPU 2002 processing color image information for a color-blind person. At step 2302, CPU 2002 receives the image for processing from, e.g., camera 1952 of FIG. 19. At step 2304, CPU 2002 selects a color in the received image, based on the type of color-blindness of the user. At step 2306, CPU 2002 analyzes the image areas having the selected color and determines the hue components of the selected color. For example, the selected color may include at least one and at most two of the following: red, yellow, green, cyan, blue, and magenta. At step 2308, CPU 2002 determines a pattern to be added to the selected color based on the hue components of the selected color. In some embodiments, different patterns and/or visual indicators may be used based on one or more hue components of the selected color. For example, each of the hue components may have associated pattern of stripes. In another example, each of the hue components may have associated patterns of stripes having unique angles. At step 2310, CPU 2002 may apply the determined pattern to portions of the image having the selected color. In some embodiments, CPU 2002 may create an overlay having the determined pattern for display on top of the image. In such a case, the received image may not be altered. The overlay may be displayed on top of the image to indicate the patterns associated with the selected color in the image. At step 2312, CPU 2002 may send the processed image (or overlay), e.g., for display in image window 1914 of FIG. 19. Accordingly, CPU 2002 processes the received image to enable the color-blind user to distinguish between various colors in the image.

Generally, the systems and methods described herein may be executed on a conventional data processing platform such as an IBM PC-compatible computer running the Windows operating systems, a SUN workstation running a UNIX operating system or another equivalent personal computer, server, or workstation. Alternatively, the system may include a dedicated processing system that includes an API programming environment.

The systems and methods described herein may also be realized as a software component operating on a conventional data processing system such as a UNIX workstation. In such an embodiment, the methods may be implemented as a computer program written in any of several languages well-known to those of ordinary skill in the art, such as (but not limited to) C, C++, FORTRAN, Java, MySQL, Perl, Python, Apache or BASIC. The methods may also be executed on commonly available clusters of processors, such as Western Scientific Linux clusters.

The systems and methods disclosed herein may be performed in either hardware, software, or any combination thereof, as those terms are currently known in the art. In particular, the present systems and methods may be carried out by software, firmware, or microcode operating on a computer or computers of any type. Additionally, software embodying the processes described herein may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Accordingly, the systems and methods described herein are not limited to any particular platform, unless specifically stated otherwise in the present disclosure.

Variations, modifications, and other implementations of what is described may be employed without departing from the spirit and scope of the disclosure. More specifically, any of the method and system features described above or incorporated by reference may be combined with any other suitable method, system, or device feature disclosed herein or incorporated by reference, and is within the scope of the contemplated systems and methods described herein. The systems and methods may be embodied in other specific forms without departing from the spirit or essential characteristics thereof. The foregoing embodiments are therefore to be considered in all respects illustrative, rather than limiting of the systems and methods described herein. The teachings of all references cited herein are hereby incorporated by reference in their entirety

1. A method for processing a color image for assisting a color blind user, comprising
receiving, at a processor, an image having one or more colors,
selecting, by the processor, a color from the image, the color having one or more hue components,
analyzing, by the processor, the color to determine the one or more hue components,
adding, by the processor, a pattern to the color, wherein the pattern is uniquely determined based on the one or more hue components of the color, and
applying, by the processor, the pattern to portions of the image having the color, whereby the pattern is distinguishable to the user.

2. (canceled)

3. (canceled)

4. The method of claim 1, wherein the color has a saturation value and the pattern has a selected density, and the selected density corresponds to the saturation value.

5. The method of claim 1, wherein the pattern includes a first set of stripes placed at a first angle.

6. The method of claim 5, wherein the first set of stripes includes a white stripe, a black stripe, and a transparent stripe.

7. (canceled)

8. The method of claim 5, wherein the first angle is determined based on a first one of the hue components.

9. The method of claim 8, wherein the first angle is unique to the first one of the hue components.

10. The method of claim 5, wherein the first set of stripes includes stripes that are at least one of solid lines, dashed lines, dotted lines, and wavy lines.

11. (canceled)

12. The method of claim 1, wherein
the hue components include a first hue component and a second hue component,
the first and second hue components are associated with a first set of stripes and a second set of stripes, respectively,
the first and second sets of stripes are disposed at first and second angles, and
the pattern added to the color includes a cross-hatching of the first and second sets of stripes.

13. (canceled)

14. A system configured to process a color image for assisting a color blind user, comprising
a data memory having stored therein a color space defined by one or more colors associated with the image, and data representative of the colors,
a first processor to select a first color from the image, the first color having one or more hue components,
a second processor to analyze the first color to determine the one or more hue components,
a third processor to modify the data representative of the first color by adding a pattern to the first color, wherein the pattern is uniquely determined based on the one or more hue components of the first color, and
a fourth processor to apply the pattern to portions of the image having the color, whereby the pattern is distinguishable to the user.

15. The system of claim 14, wherein the first color is visible through the pattern.

16. (canceled)

17. (canceled)

18. The system of claim 14, wherein the pattern includes a first set of stripes placed at a first angle.

19. (canceled)

20. (canceled)

21. The system of claim 18, wherein the first angle is determined based a first one of the hue components.

22. (canceled)

23. (canceled)

24. (canceled)

25. (canceled)

26. (canceled)

27. The system of claim 14, wherein at least one of the data memory, the first processor, the second processor, the third processor, and the fourth processor are disposed in an embedded system having a camera.

28. (canceled)

29. A method for processing a color image on a mobile device for assisting a color blind user, the mobile device having a processor, a camera, and a screen, comprising:
receiving an image at the processor, from the camera, the image having one or more colors;
receiving, at the processor, an input command to process the received image;
selecting, by the processor, a color from the image, the color having one or more hue components;
analyzing, by the processor, the color to determine the one or more hue components;
adding, by the processor, a pattern to the color, wherein the pattern is uniquely determined based on the one or more hue components of the color,
applying, by the processor, the pattern to portions of the image having the color to create a processed image, whereby the pattern is distinguishable to the color blind user; and
displaying the processed image on the screen to the color blind user.

30. The method of claim 29, wherein the input command to process the received image is received from the color blind user via a user input device.

31. (canceled)

32. The method of claim 29, comprising:
initiating, by the processor, a color blindness test to determine type of color blindness of the color blind user,
receiving input, at the processor, from the color blind user,
determining, by the processor, the type of color blindness of the color blind user based on the received input, and
generating, by the processor, the input command to process the received image.

33. (canceled)

34. The method of claim 29, wherein the color blindness test is initiated by the processor in response to receiving the input command to process the received image from the color blind user via a user input device.

35. The method of claim 32, wherein the color is selected from the image based on the type of color blindness of the color blind user.

36. (canceled)

37. The method of claim 29, wherein processing the color image is performed in real time.

38. The method of claim 37, wherein the color image is a frame of a live video feed, and the processing the color image is performed on each frame of the live video feed in real time.

39. (canceled)
